(19) United States
(12) Patent Application Publication
(10) Pub. No.: US 2023/0314972 A1
(43) Pub. Date: Oct. 5, 2023

(54) TONER AND TWO-COMPONENT DEVELOPER

(71) Applicant: CANON KABUSHIKI KAISHA, Tokyo (JP)

(72) Inventors: TAKESHI HASHIMOTO, Ibaraki (JP); MEGUMI SHINO, Chiba (JP); HAYATO IDA, Ibaraki (JP)

(21) Appl. No.: 18/189,415

(22) Filed: Mar. 24, 2023

(30) Foreign Application Priority Data
Mar. 31, 2022 (JP) 2022-059846

(51) Int. Cl. G03G 9/087

(52) U.S. Cl. CPC G03G 9/08728; G03G 9/08755

(57) ABSTRACT

A toner, comprising a toner particle comprising a binder resin, wherein in a viscoelasticity measurement performed on a molded sample resulting from compression molding of the toner to a disc shape, and in which a strain in the molded sample is caused to vary, at 90° C., a storage elastic modulus G′(1) of the molded sample at 1% strain is 7500 to 30000 Pa, and a storage elastic modulus G′(50) of the molded sample at 50% strain is 950 to 6000 Pa.

### BACKGROUND OF THE INVENTION

### Field of the Invention

The present disclosure relates to a toner that is used in electrophotographic systems, electrostatic recording systems, electrostatic printing systems, and toner jet systems, and relates to a two-component developer that utilizes that toner.

### Description of the Related Art

The demand for delivering higher printing speeds and greater energy savings has become more exacting in recent years, accompanying the growing use of electrophotographic full-color copiers. In the framework of the Sustainable Development Goals (SDGs) adopted by the United Nations, in particular, efforts are being made worldwide that are aimed at curbing greenhouse gases such as CO₂, while energy conservation demands are likewise becoming stronger. Energy-saving approaches being addressed include techniques for fixing toner at a lower temperature, for the purpose of reducing power consumption in a fixing process.

As is known, low-temperature fixability superior to that of toners having an amorphous resin as a main component is achieved through the use of a crystalline resin having a sharp melt property, as the main component of a binder resin of the toner. Various toners that utilize crystalline resins having a sharp melt property have therefore been proposed.

For instance Japanese Patent Application Publication No. 2005-266546 discloses a toner having a crystalline polyester as a main component, and a toner in which a crystalline polyester and an amorphous resin are used concomitantly.

### SUMMARY OF THE INVENTION

Fixing of toner at a lower fixation temperature than in conventional toners has thus been made possible through the use of a toner having, as a main component, a crystalline resin having a sharp melt property. However, studies by the inventors have revealed a new problem in that character reproducibility and dot reproducibility of such a toner are poorer than those of conventional toners.

It is an object of the present invention to provide a toner of outstanding fixing performance even at a low fixation temperature, while exhibiting superior character reproducibility and dot reproducibility, and to provide a two-component developer comprising the toner.

The first aspect of the present disclosure relates to a toner, comprising a toner particle comprising a binder resin,
wherein in a viscoelasticity measurement performed on a molded sample resulting from compression molding of the toner to a disc shape, and in which a strain in the molded sample is caused to vary, at 90° C.,
a storage elastic modulus G′(1) of the molded sample at 1% strain is 7500 to 30000 Pa, and
a storage elastic modulus G′(50) of the molded sample at 50% strain is 950 to 6000 Pa.

The second aspect of the present disclosure relates to a toner, comprising a toner particle comprising a binder resin,
wherein the binder resin comprises a crystalline resin;
the crystalline resin is a crystalline vinyl resin
   having at least first monomer units represented by Formula (1); and
   having at least two of monomer units selected from the group consisting of second monomer units represented by Formula (2), or
   having second monomer units represented by Formula (2) and third monomer units represented by Formula (3); and
a content ratio of an incineration ash of a tetrahydrofuran-insoluble fraction of the toner is 5 to 30 mass % based on a mass of the toner:

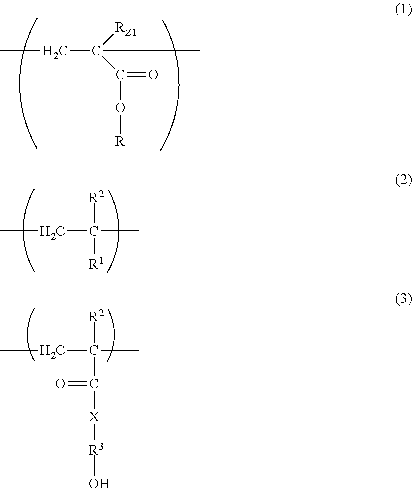

in Formula (1), R_{z1} represents a hydrogen atom or a methyl group, and R represents an alkyl group having 18 to 36 carbon atoms;
in Formula (2), R¹ is —C≡N,
C(═O)NHR¹⁰ (where R¹⁰ represents a hydrogen atom or an alkyl group having 1 to 4 carbon atoms),
a hydroxy group,
—COOR¹¹ (where R¹¹ represents a hydrogen atom or an alkyl group having 1 to 6 carbon atoms), or
—NH—C(═O)—N(R¹³)₂ (where the two R¹³ represent each independently a hydrogen atom or an alkyl group having 1 to 6 carbon atoms), and
R² represents a hydrogen atom or a methyl group; and
in Formula (3), X represents 0 or NH, R² represents a hydrogen atom or a methyl group, and R³ represents an alkylene having 2 to 6 carbon atoms.

The present disclosure allows providing a toner of outstanding fixing performance even at a low fixation temperature, while exhibiting superior character reproducibility and dot reproducibility, and providing a two-component developer comprising the toner. Further features of the present invention will become apparent from the following description of exemplary embodiments.

### DESCRIPTION OF THE EMBODIMENTS

In the present disclosure, the terms “from XX to YY” and “XX to YY”, which indicate numerical ranges, mean numerical ranges that include the lower limits and upper limits that are the end points of the ranges.

In the present disclosure, a (meth)acrylic acid ester means an acrylic acid ester and/or a methacrylic acid ester.

In cases where numerical ranges are indicated incrementally, upper limits and lower limits of the numerical ranges can be arbitrarily combined.

The term “monomer unit” describes a reacted form of a monomeric material in a polymer. For example, one carbon-carbon bonded section in a principal chain of polymerized vinyl monomers in a polymer is given as one unit. A vinyl monomer can be represented by the following formula (Z):

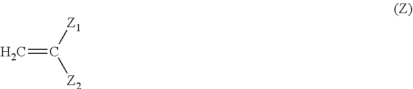

in formula (Z), Z₁ represents a hydrogen atom or alkyl group (preferably a alkyl group having 1 to 3 carbon atoms, or more preferably a methyl group), and Z₂ represents any substituent.

A crystalline resin is a resin exhibiting a clear endothermic peak in differential scanning calorimetry (DSC) measurement.

In the features set forth concerning the toner of the first aspect and the features set forth concerning the toner of the second aspect, those features set forth concerning the toner of one of the aspects may be adopted, as needed, as features set forth concerning of the toner of the other aspect.

The first aspect of the present disclosure relates to a toner, comprising a toner particle comprising a binder resin,
wherein in a viscoelasticity measurement performed on a molded sample resulting from compression molding of the toner to a disc shape, and in which a strain in the molded sample is caused to vary, at 90° C.,
a storage elastic modulus G′(1) of the molded sample at 1% strain is 7500 to 30000 Pa, and
a storage elastic modulus G′(50) of the molded sample at 50% strain is 950 to 6000 Pa.

The inventors speculated the following, concerning the underlying reasons why the above toner is inferior in terms of character reproducibility and dot reproducibility as compared with conventional toners.

The temperature required for the toner to start deforming is lower in toners exhibiting superior low-temperature fixability, typified by toners containing a large amount of crystalline resin, than in conventional toners. As a result, toner having been transferred onto paper deforms and spreads, on the paper, on account of radiant heat received from a fixing belt and a film, before the toner undergoes deformation on account of the heat and pressure received from these members, in a fixing process. It has been thought that character reproducibility and dot reproducibility would become impaired as a result.

With a view to suppressing this phenomenon the inventors speculated that it is necessary to confer the toner with a characteristic such that the toner does not deform just on account of heat in the fixing process, but does only so by being acted upon by pressure along with heat.

Firstly, the inventors figured out that the temperature for which characters and dots reproducibility decreases at the time of fixing of the toner, despite the fact that the toner exhibits superior low-temperature fixability, lies at around 90° C. On the basis of this finding the inventors studied assiduously toners having had the characteristics thereof at 90° C. modified in various ways, and arrived as a result at the present disclosure.

With respect to the toner of the first aspect, in a viscoelasticity measurement performed on a molded sample resulting from compression molding of the toner to a disc shape, and in which a strain in the molded sample is caused to vary, at 90° C., a storage elastic modulus G′(1) of the molded sample at 1% strain is 7500 Pa to 30000 Pa, and a storage elastic modulus G′(50) of the molded sample at 50% strain is 950 Pa to 6000 Pa.

Herein, the strain in the molded sample at a time of 0 Pa stress applied to the molded sample is 0%. The storage elastic modulus obtained as a result of viscoelasticity measurement of a molded sample corresponds to the elastic modulus of the toner as described below.

Also, it is possible to set a strain value in the below-described viscoelasticity measurement in which the strain in the molded sample is caused to vary.

It is deemed that the storage elastic modulus G′(1) of the molded sample at 1% strain corresponds to the elastic modulus of the toner at a time where virtually no pressure acts upon the toner in the fixing process.

Reproducibility of characters and dots is good when G′(1) lies in the range from 7500 Pa to 30000 Pa. Further, G′(1) is preferably from 8200 Pa to 28000 Pa, more preferably from 10000 Pa to 27000 Pa, yet more preferably from 13000 Pa to 26000 Pa, and particularly preferably from 15000 Pa to 25000 Pa.

When G′(1) is lower than 7500 Pa, the toner deforms readily only by heat, which translates into in poor character reproducibility and dot reproducibility. When on the other hand G′(1) exceeds 30000 Pa, it becomes difficult for the below-described G′(50) to lie within the ranges of the present disclosure, and in particular low-temperature fixability worsens.

It is deemed that the storage elastic modulus G′(50) of the molded sample at 50% strain corresponds herein to the hardness of the toner when acted upon by heat and pressure in the fixing process. Studies by the inventors have revealed that the thickness of a toner layer on paper after fixing is about half the thickness prior to fixing, and accordingly the numerical value of the storage elastic modulus G′(50) of the molded sample measured at 50% strain is important.

The toner can exhibit excellent low-temperature fixability when G′(50) lies in the range from 950 Pa to 6000 Pa. Preferably, G′(50) ranges from 1000 Pa to 5500 Pa, more preferably from 1500 Pa to 4000 Pa, and particularly preferably from 1800 Pa to 3000 Pa.

When G′(50) is lower than 950 Pa, storage elastic modulus becomes too low when heat and pressure act upon the toner in the fixing process, which translates into a poorer hot offset property. On the other hand, low-temperature fixability decreases when G′(50) exceeds 6000 Pa.

A method for measuring the storage elastic modulus will be described further on.

An explanation follows next on a toner configuration that yields storage elastic moduli G′(1) and G′(50) such as those above.

By selecting as appropriate the binder resin that is used it becomes possible to bring G′(1) or G′(50) so as to lie in the above ranges. Criteria for binder resin selection may include, for a binder resin having an amorphous resin as a main component, selecting as appropriate the molecular weight, the glass transition temperature and the softening point of the resin, and the constituent monomers of the amorphous resin. In a binder resin containing a crystalline resin as a main component there may be appropriately selected the melting point, the molecular weight and the softening point of the resin and the constituent monomers of the resin.

The storage elastic modulus G′(1) or G′(50) of the molded sample can also be adjusted by relying on other means for adjusting the storage elastic modulus of the toner.

Such other methods are not particularly limited, and include for instance a means for reducing the storage elastic modulus through addition of a crystalline resin or plasticizer having a plasticizing effect, to a binder resin having an amorphous resin as a main component, and a means for increasing the storage elastic modulus through addition of fine particles or a compound having a filler effect.

It is however difficult to set G′(1) and G′(50) to lie in the above ranges by relying on the above means.

When the viscoelasticity is measured while causing strain to vary, generally the storage elastic modulus tends to exhibit substantially the same value, or to decrease slightly as the strain increases. Studies by the inventors have revealed that in toner configurations known in the art, G′(50) decreases by just about 10%, at most, relative to G′(1). That is, even if one from among G′(1) and G′(50) is controlled to lie within the above ranges by simply relying on the above-described means, this does not imply that the other storage elastic modulus can be satisfied by doing so.

Therefore, the inventors envisaged conferring the toner with characteristics such that the storage elastic modulus changes significantly, depending on the magnitude of strain, and assiduously studied this approach.

As a result the inventors found that a toner characteristic whereby the storage elastic modulus varies significantly depending on the magnitude of strain can be imparted by resorting for instance to a means for selecting appropriate monomers, as the monomers of the binder resin, a means for incorporating a plurality of types of filler component into a toner particle, and a means resulting from combining the foregoing means. In consequence, G′(1) and G′(50) could be set within the above ranges.

More specifically it was found that the storage elastic modulus readily varies significantly, depending on the magnitude of strain, by using a crystalline resin having specific monomer units, as the binder resin, and by using concomitantly a filler component of inorganic fine particles and/or a filler component of an organic pigment having a sub-micron particle diameter, and a gel component of a binder resin.

The toner comprises a toner particle. The toner particle comprises a binder resin.

The binder resin preferably comprises a crystalline resin. The content ratio of the crystalline resin in the binder resin is not particularly limited, but is preferably from 35 mass % to 75 mass %, more preferably from 40 mass % to 70 mass %, and preferably from 50 mass % to 60 mass %.

A known crystalline resin can be used as the crystalline resin. Examples include crystalline polyesters, crystalline vinyl resins, crystalline polyurethanes and crystalline polyureas. Further examples include ethylene copolymers such as ethylene-vinyl acetate copolymers, ethylene-methyl acrylate copolymers, ethylene-ethyl acrylate copolymers, ethylene-butyl acrylate copolymers, ethylene-methyl methacrylate copolymers, ethylene-methacrylic acid copolymers and ethylene-acrylic acid copolymers.

Preferred among the foregoing are crystalline polyester resins and crystalline vinyl resins, from the viewpoint of low-temperature fixability. A crystalline vinyl resin is yet more preferably used, from the viewpoint of charging stability in high-temperature, high-humidity-environments.

The crystalline polyester resin is preferably a condensation polymerization product of a monomer composition that contains an aliphatic diol having 2 to 22 carbon atoms and an aliphatic dicarboxylic acid having 2 to 22 carbon atoms as a main component. The term main component signifies herein that the content ratio of the component in the monomer composition is 50 mass % or higher. More preferably, the content ratio is 70 mass % or higher, and yet more preferably 90 mass % or higher.

The aliphatic diol having 2 to 22 (more preferably 6 to 12) carbon atoms is not particularly limited, but is preferably a chain (more preferably a linear) aliphatic diol; examples thereof include for instance ethylene glycol, diethylene glycol, triethylene glycol, 1,2-propanediol, 1,3-propanediol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, dodecamethylene glycol and neopentyl glycol. Preferred examples among the foregoing are 1,6-hexanediol, 1,10-decanediol and 1,12-dodecanediol.

Polyhydric alcohol monomers other than the above aliphatic diols can also be used. Examples of dihydric alcohol monomers among the above polyhydric alcohol monomers include aromatic alcohols such as polyoxyethylenated bisphenol A and polyoxypropylenated bisphenol A; as well as 1,4-cyclohexanedimethanol.

Among the above polyhydric alcohol monomers there is preferably used a trihydric or higher polyhydric alcohol monomer. Although crystalline polyesters ordinarily have hydroxy groups or carboxy groups at the ends of the main chain, a crystalline polyester resin can herein be readily obtained that has hydroxy groups not directly bonded to the polyester main chain, by using these trihydric or higher polyhydric alcohol monomers. Through the use of such a crystalline polyester resin a binder resin can be easily obtained that readily satisfies the physical properties according to the first aspect of the present disclosure.

Trihydric or higher polyhydric alcohol monomers among the above polyhydric alcohol monomers include aromatic alcohols such as 1,3,5-trihydroxymethylbenzene, and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane and tritrimethylolpropane.

A monohydric alcohol may also be used so long as the characteristics of the crystalline polyester resin are not impaired thereby. Examples of the monohydric alcohol include monofunctional alcohols such as n-butanol, isobutanol, sec-butanol, n-hexanol, n-octanol, lauryl alcohol, 2-ethylhexanol, decanol, cyclohexanol, benzyl alcohol and dodecyl alcohol.

The aliphatic dicarboxylic acid having 2 to 22 (more preferably 6 to 12) carbon atoms compound is not particularly limited, but is preferably a chain (more preferably a linear) aliphatic dicarboxylic acid. Concrete examples include oxalic acid, malonic acid, succinic acid, glutaric acid, adipic acid, pimelic acid, suberic acid, glutaconic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, maleic acid, fumaric acid, mesaconic acid, citraconic acid and itaconic acid. Examples include also hydrolysis products of acid anhydrides or lower alkyl esters of the foregoing. More preferred are herein adipic acid, sebacic acid and 1,10-decanedicarboxylic acid.

Polyvalent carboxylic acids other than the above aliphatic dicarboxylic acid compounds having 2 to 22 carbon atoms (hereafter also referred to as other polyvalent carboxylic acids) can likewise be used.

Examples of divalent carboxylic acids, among other polyvalent carboxylic acid monomers, include aromatic carboxylic acids such as isophthalic acid and terephthalic acid; aliphatic carboxylic acids such as n-dodecylsuccinic acid and n-dodecenylsuccinic acid; and alicyclic carboxylic acids such as cyclohexanedicarboxylic acid cyclohexanedicarboxylic acid, as well as acid anhydrides and lower alkyl esters of the foregoing.

Examples of trivalent or higher polyvalent carboxylic acids from among other carboxylic acid monomers include aromatic carboxylic acids such as 1,2,4-benzenetricarboxylic acid (trimellitic acid), 2,5,7-naphthalenetricarboxylic acid, 1,2,4-naphthalenetricarboxylic acid and pyromellitic acid; and aliphatic carboxylic acids such as 1,2,4-butanetricarboxylic acid, 1,2,5-hexanetricarboxylic acid and 1,3-dicarboxy-2-methyl-2-methylene carboxypropane; and also derivatives such as acid anhydrides and lower alkyl esters of the foregoing.

Trivalent or higher polyvalent carboxylic acid monomers are preferably used herein, from among the above polyvalent carboxylic acid monomers. Although crystalline polyesters ordinarily have a hydroxy group or a carboxy group at the end of the main chain, a crystalline polyester resin having a carboxy group not directly bonded to the polyester main chain can however be readily obtained through the use of such trivalent or higher polyvalent carboxylic acid monomers. By using such a crystalline polyester resin a binder resin can thus be easily obtained that readily satisfies physical properties according to the first aspect of the present disclosure.

The binder resin may contain a monovalent carboxylic acid, so long as the characteristics of the crystalline polyester resin are not impaired thereby. Examples of monovalent carboxylic acids include monocarboxylic acids such as benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, decanoic acid, dodecanoic acid and stearic acid.

The crystalline polyester resin can be produced in accordance with an ordinary polyester synthesis method. For instance a carboxylic acid monomer and an alcohol monomer described above can be subjected to an esterification reaction or transesterification reaction, followed by a condensation polymerization reaction in accordance with an ordinary method, under reduced pressure or under introduction of nitrogen gas, so that a desired crystalline polyester resin can be obtained as a result.

The esterification or transesterification reaction can be conducted, as the case may require, using an ordinary esterification catalyst or transesterification catalyst such as sulfuric acid, titanium butoxide, dibutyltin oxide, manganese acetate or magnesium acetate.

Further, the condensation polymerization reaction can be carried out using an ordinary polymerization catalyst, for instance a known catalyst such as titanium butoxide, dibutyltin oxide, tin acetate, zinc acetate, tin disulfide, antimony trioxide or germanium dioxide. The polymerization temperature and the amount of catalyst are not particularly limited, and may be established as appropriate.

In the esterification or transesterification reaction, or polycondensation reaction, a method may be resorted to in which all the monomers are added at once, for the purpose of increasing the strength of the crystalline polyester resin that is obtained; alternatively, divalent monomers are caused to react first, in order to reduce the amount of the low molecular weight component, followed by addition and reaction of trivalent and higher monomers.

The crystalline resin is more preferably a crystalline vinyl resin, and more preferably has first monomer units represented by Formula (1) below (hereafter also simply referred to as first monomer units).

Preferably, the content ratio of the first monomer units in the crystalline vinyl resin is from 20.0 mass % to 100.0 mass %, since in that case the vinyl resin exhibits crystallinity, and readily brings out both low-temperature fixability and hot offset resistance.

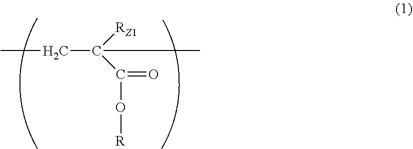

In Formula (1), R_{z1} represents a hydrogen atom or a methyl group, and R represents an alkyl group having 18 to 36 carbon atoms. Further, R is preferably an alkyl group having 18 to 30 carbon atoms. Also, the alkyl group preferably has a linear structure.

The first monomer units have an alkyl group having 18 to 36 carbon atoms represented by R, in a side chain, such that the crystalline vinyl resin readily develops crystallinity by virtue of having such a moiety.

In a case where the content ratio of the first monomer units in the crystalline vinyl resin is lower than 20.0 mass %, crystallinity does not develop readily, and low-temperature fixability is prone to drop. The content ratio of the first monomer units in the crystalline vinyl resin is preferably 40.0 mass % or higher, and more preferably 50.0 mass % or higher. The upper limit is not particularly restricted, but in a case where the resin contains other monomer units described further on, the content ratio of the first monomer units is preferably 90.0 mass % or lower, and more preferably 80.0 mass % or lower.

Crystalline vinyl resins exhibit superior charge retention properties in high-temperature, high-humidity-environments as compared with conventionally known crystalline polyesters which are crystalline resins, possibly due to the fact that the side chains of crystalline vinyl resins have a crystalline structure.

The first monomer units are monomer units derived from at least one monomer (first polymerizable monomer) selected from the group consisting of (meth)acrylic acid esters having an alkyl group having 18 to 36 carbon atoms.

Examples of (meth)acrylic acid esters having an alkyl group having 18 to 36 carbon atoms include (meth)acrylic acid esters having a linear C18 to C36 alkyl group [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate and dotriacontanyl (meth)acrylate)], and (meth)acrylic acid esters having a branched alkyl group having 18 to 36 carbon atoms [for instance 2-decyltetradecyl (meth)acrylate].

Preferred among the foregoing is at least one selected from the group consisting of (meth)acrylic acid esters having a linear alkyl group having 18 to 36 carbon atoms, from the viewpoint of the low-temperature fixability of the toner. Yet more preferable is at least one selected from the group consisting of (meth)acrylic acid esters having a linear alkyl group having 18 to 30 carbon atoms. Yet more preferable is at least one selected from the group consisting of linear stearyl (meth)acrylate and linear behenyl (meth)acrylate.

The monomers that form the first monomer units may be used singly as one type; alternatively, two or more types thereof may be used concomitantly.

The crystalline vinyl resin may contain monomer units other than the first monomer units.

Examples of polymerizable monomers that form other monomer units other than the first monomer units include those exemplified below. The polymerizable monomers that form other monomer units may be used singly or in combinations of two or more types thereof.

Such other monomer units other than the first monomer units can be roughly divided into second monomer units represented by Formula (2) below (hereafter also simply referred to as “second monomer units”, third monomer units represented by Formula (3) below (hereafter also simply referred to as “third monomer units”), and monomer units other than the first monomer units, second and third monomer units.

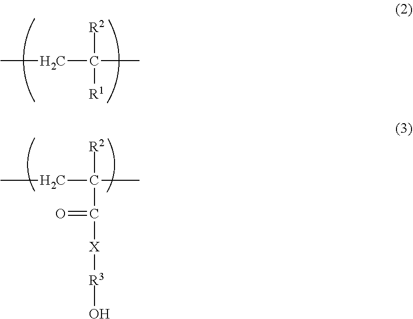

In Formula (2), R¹ is —C≡N,
C(═O)NHR¹⁰ (where R¹⁰ represents a hydrogen atom or an alkyl group having 1 to 4 carbon atoms),
a hydroxy group,
—COOR¹¹ (where R¹¹ represents a hydrogen atom or an alkyl group having 1 to 6 carbon atoms),
—NH—C(═O)—N(R¹³)₂ (where the two R¹³ represent each independently a hydrogen atom or an alkyl group having 1 to 6 carbon atoms), and
R² represents a hydrogen atom or a methyl group; and
in Formula (3), X represents 0 or NH, R² represents a hydrogen atom or a methyl group, and R³ represents an alkylene having 2 to 6 carbon atoms.

The second monomer units have a polar group directly bonded to the main chain of the crystalline vinyl resin. Examples of polymerizable monomers that form the second monomer units include the following polymerizable monomers.

Monomers having a nitrile group; for instance acrylonitrile, methacrylonitrile, and the like.

Monomers having a hydroxy group; for instance 2-hydroxyethyl (meth)acrylate and 2-hydroxypropyl (meth)acrylate.

Monomers having an amide group; for instance acrylamide and monomers obtained through a reaction, in accordance with a known method, of an amine having 1 to 30 carbon atoms and a carboxylic acid having 2 to 30 carbon atoms and having an ethylenically unsaturated bond (such as acrylic acid or methacrylic acid).

For instance monomers obtained through reaction, in accordance with known methods, of an amine having 3 to 22 carbon atoms (a primary amine (for instance n-butyl amine, t-butyl amine, propyl amine or isopropyl amine), a secondary amine (for instance di-n-ethyl amine, di-n-propyl amine or di-n-butyl amine), aniline, cycloxylamine or the like), with an isocyanate having 2 to 30 carbon atoms and having an ethylenically unsaturated bond.

Monomers having a carboxy group; for instance methacrylic acid, acrylic acid and 2-carboxyethyl (meth)acrylate.

Vinyl esters; for instance vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate and vinyl octylate.

The third monomer units have a polar hydroxy group at a position spaced from the main chain. Examples of polymerizable monomers that form the third monomer units include the following polymerizable monomers.

2-hydroxyethyl (meth)acrylate, 2-hydroxypropyl (meth)acrylate, 2-hydroxyethylamide (meth)acrylate and 2-hydroxypropylamide (meth)acrylate.

Examples of polymerizable monomers that form monomer units, other than the first, second and third monomer units include the following polymerizable monomers.

Styrene and derivatives thereof such as styrene and o-methylstyrene, as well as (meth)acrylic acid esters such a methyl (meth)acrylate, n-butyl (meth)acrylate, t-butyl (meth)acrylate and 2-ethylhexyl (meth)acrylate.

Unsaturated monoolefins such as ethylene, propylene, butylene and isobutylene; and unsaturated polyenes such as butadiene and isoprene.

Aromatic divinyl compounds; diacrylate compounds having an alkyl chain bridge; diacrylate compounds having an alkyl chain bridge containing an ether bond; diacrylate compounds having a bridge in the form of a chain containing an aromatic group and an ether bond; polyester-type diacrylates; and multifunctional crosslinking agents. Examples of aromatic divinyl compounds include divinylbenzene and divinylnaphthalene.

Examples of the above diacrylate compounds having an alkyl chain bridge include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and compounds resulting from replacing the acrylate in the foregoing compounds with methacrylate.

Styrene is preferable herein as a polymerizable monomer that forms monomer units other than the first, second and third monomer units, since styrene tends to improve readily charging stability in high-temperature, high-humidity conditions.

Monomers having a nitrile group, an amide group, a urethane group or a urea group are preferably used as the polymerizable monomers that form the monomer units other than the first monomer units. More preferably, such monomers are monomers having an ethylenically unsaturated bond and at least one functional group selected from the group consisting of nitrile groups, amide groups, urethane groups and urea groups. Charge rising properties in low humidity-environments are improved through the use of such monomers.

The crystalline resin preferably has second monomer units, more preferably, the crystalline resin has at least two of monomer units selected from among the second monomer units, or has second monomer units and third monomer units, and yet more preferably, the crystalline resin has second monomer units and third monomer units. In these cases, the polymerizable monomers that form the second monomer units are preferably at least one type selected from the group consisting of acrylonitrile, methacrylonitrile, acrylic acid and methacrylic acid and the polymerizable monomers that form the third monomer units are at least one type selected from the group consisting of 2-hydroxyethyl (meth)acrylate and 2-hydroxypropyl (meth)acrylate. Yet more preferably, the polymerizable monomers that form the second monomer units are at least one type selected from the group consisting of acrylonitrile and methacrylonitrile.

Character reproducibility, dot reproducibility and low-temperature fixability can all be achieved at a high level through the concomitant use of such polymerizable monomers.

Acrylonitrile or methacrylonitrile is more preferable as a monomer in which the nitrile group or carboxy group is directly bonded to an ethylenically unsaturated bond.

In such a configuration, monomer units (second monomer units) having a polar group such as a nitrile group or a carboxy group are directly bonded to the main chain of the crystalline vinyl resin, and monomer units (third monomer units) having a hydroxy group that is not directly bonded to the main chain of the crystalline vinyl resin, are co-present within the resin.

Upon toner melting, the polar groups in the crystalline vinyl resin interact with each other on account of electric dipole interactions; as a result, the viscosity and elastic modulus of the toner increases as compared with a resin having no polar groups.

In the second monomer units a polar functional group is directly bonded to a main chain that contributes significantly to molecular mobility. After toner melting, therefore, the storage elastic modulus of the crystalline vinyl resin is higher than that of a crystalline vinyl resin having no polar groups directly bonded to the main chain of the resin.

By contrast, the third monomer units have a polar hydroxy group that is present off the main chain. After toner melting, therefore, the storage elastic modulus increases less readily as compared with a crystalline vinyl resin having a polar groups directly bonded to the main chain of the resin.

It is deemed that when toner strain is small in a case where the second monomer units and the third monomer units are co-present, part of the polar groups of the third monomer units interact with the polar groups of the second monomer units. As a result, the action of the polar groups directly bonded to the main chain in the second monomer units becomes stronger, and the storage elastic modulus increases.

It is further deemed that upon application of pressure from a fixing member, interactions between the polar groups of the third monomer units and the polar groups of the second monomer units are weaker, and molecular mobility increases, as a result of which the viscosity the toner decreases. That is, the storage elastic modulus can be caused to vary significantly between that when the toner is acted upon by heat alone, and that when the material toner is acted upon by an external force, along with heat.

When the crystalline vinyl resin is a vinyl-based resin, it the resin can be produced using the exemplified polymerizable monomers and a polymerization initiator. From the viewpoint of efficiency, the polymerization initiator is preferably used in an amount from 0.05 parts by mass to 10.00 parts by mass relative to 100.00 parts by mass of the polymerizable monomers.

Examples of the polymerization initiator include the following.

ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy)butane, tert-butylhydroperoxide, cumene hydroperoxide, 1,1,3,3-tetramethylbutylhydroperoxide, di-tert-butyl peroxide, tert-butylcumyl peroxide, dicumyl peroxide, a,a′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

From the viewpoint of charging stability, the acid value of the crystalline resin used as the binder resin of the present disclosure is preferably from 0 mgKOH/g to 100 mgKOH/g, more preferably from 10 mgKOH/g to 60 mgKOH/g, yet more preferably from 15 mgKOH/g to 50 mgKOH/g and particularly preferably from 20 mgKOH/g to 30 mgKOH/g.

Similarly, the hydroxyl value is preferably from 0 mgKOH/g to 100 mgKOH/g, more preferably from 10 mgKOH/g to 75 mgKOH/g, yet more preferably from 15 mgKOH/g to 70 mgKOH/g, and particularly preferably from 18 mgKOH/g to 60 mgKOH/g.

The toner of the first aspect preferably further comprises an amorphous resin as the binder resin. The content ratio of the amorphous resin of the binder resin is not particularly limited, and is preferably from 25 mass % to 65 mass %, more preferably from 30 mass % to 60 mass % and yet more preferably from 40 mass % to 50 mass %.

A known amorphous resin can be used as the amorphous resin. Examples include the following.

Polyvinyl chloride, phenolic resins, natural resin-modified phenolic resins, natural resin-modified maleic acid resins, polyvinyl acetate, silicone resins, polyester resins, polyurethane resins, polyamide resins, furan resins, epoxy resins, xylene resins, polyvinyl butyral, terpene resins, coumarone-indene resins, petroleum resins and vinyl-based resins.

Among the foregoing the toner contains preferably at least one resin selected from the group consisting of a hybrid resin in which a vinyl-based resin and a polyester resin are bonded to each other, a polyester resin and a vinyl-based resin.

Amorphous polyester resins are yet more preferable. The value of the storage elastic modulus G′(1) is easily increased through the use of an amorphous polyester resin. In consequence, G′(1) and G′(50) can be set to lie within the above ranges. As a result, hot offset resistance, low-temperature fixability, and dot reproducibility are readily combined at a high level.

Polyester resins that are ordinarily used in toners can be suitably used herein as the amorphous polyester resin. Examples of the monomers used in the above polyester resin include polyhydric alcohols (dihydric, trihydric or higher alcohols), and polyvalent carboxylic acids (divalent, trivalent or higher carboxylic acids) and acid anhydrides or lower alkyl esters thereof.

Examples of the above polyhydric alcohols include those set out below.

Examples of dihydric alcohols include the following bisphenol derivatives.

Polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, polyoxypropylene (6)-2,2-bis(4-hydroxyphenyl)propane and the like.

Other polyhydric alcohols include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, tritrimethylolpropane and 1,3,5-trihydroxymethylbenzene.

These polyhydric alcohols can be used singly or in combinations of a plurality thereof.

Examples of the above polyvalent carboxylic acids include those below.

Examples of divalent carboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid and isooctylsuccinic acid, as well as anhydrides and lower alkyl esters of these acids. Preferably among the foregoing there is used maleic acid, fumaric acid, terephthalic acid, n-dodecenylsuccinic acid or adipic acid.

In a case in particular where the above-described crystalline vinyl resin is used as the crystalline resin, the divalent carboxylic acid that is used is preferably an alkenylsuccinic acids such as n-dodecenyl succinic acid, isododecenyl succinic acid, n-octenyl succinic acid or isooctenyl succinic acid. Through the use of an alkenylsuccinic acid the amorphous resin can thus contain monomer units derived from an alkenylsuccinic acid. The monomer units of the alkenylsuccinic acid have an alkenyl group, and accordingly the monomer units interact readily with long-chain alkyl units having 18 to 30 carbon atoms of the crystalline vinyl resin. These interactions are weaker than interactions between polar groups. Therefore, although the filler effect is readily brought out on account of these interactions when toner strain is small, such interactions fail however to be brought out readily when toner strain is large, and hence the filler effect is hard to elicit. As a result, G′(1) and G′(50) can be set to lie in the above ranges.

Examples of trivalent or higher carboxylic acids, and anhydrides and lower alkyl esters thereof, include the following.

1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylene carboxypropane, 1,2,4-cyclohexanetricarboxylic acid, tetra(methylene carboxy)methane, 1,2,7,8-octane tetracarboxylic acid, pyromellitic acid and Empol trimer acids, as well as acid anhydrides and lower alkyl esters thereof.

Preferred among the foregoing is 1,2,4-benzenetricarboxylic acid (trimellitic acid) or derivatives such as acid anhydrides thereof, since these are inexpensive and afford easy reaction control.

These polyvalent carboxylic acids can be used singly or in combinations of a plurality thereof.

The method for producing the polyester resin is not particularly limited, and a known method can be resorted to herein. For instance, a polyhydric alcohol and a polyvalent carboxylic acid described above are simultaneously charged, and are polymerized as a result of an esterification reaction or a transesterification reaction, and a condensation reaction, to produce a polyester resin. The polymerization temperature is not particularly limited, but lies preferably in the range from 180° C. to 290° C. For instance a polymerization catalyst such as a titanium-based catalyst, a tin-based catalyst, zinc acetate, antimony trioxide or germanium dioxide can be used in polymerization of polyester resins.

The polyester resin used in the amorphous resin is preferably obtained through condensation polymerization using at least one from among a titanium-based catalyst and a tin-based catalyst.

Examples of vinyl resins used as amorphous resins include polymers of polymerizable monomers containing ethylenically unsaturated bonds. The term ethylenically unsaturated bond denotes a carbon-carbon double bond capable of undergoing radical polymerization, and may be for instance a vinyl group, a propenyl group, an acryloyl group or a methacryloyl group.

Examples of polymerizable monomers include the following.

Styrenic monomers such as styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxy styrene, p-chlorostyrene, 3,4-dichlorostyrene, m-nitrostyrene, o-nitrostyrene, p-nitrostyrene;
acrylic acids and acrylic acid esters such as acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate and phenyl acrylate;
α-methylene aliphatic monocarboxylic acids and esters thereof, such as methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate;
as well as acrylonitrile, methacrylonitrile and acrylamide.

Further examples include acrylic acid esters or methacrylic acid esters such as 2-hydroxyethyl acrylate, 2-hydroxyethyl methacrylate, 2-hydroxypropyl methacrylate, as well as polymerizable monomers having a hydroxy group, such as 4-(1-hydroxy-1-methylbutyl) styrene and 4-(1-hydroxy-1-methylhexyl) styrene. The foregoing can be used singly or in combinations of a plurality of types thereof.

Among the foregoing there is preferably used a monomer that is a condensation product of an alcohol having 6 to 22 carbon atoms and an acrylic acid or methacrylic acid such as n-octyl acrylate, dodecyl acrylate, 2-ethylhexyl acrylate, stearyl acrylate, n-octyl methacrylate, dodecyl methacrylate, 2-ethylhexyl methacrylate or stearyl methacrylate.

These monomers interact readily with long-chain alkyl units having 18 to 30 carbon atoms in the crystalline vinyl resin. These interactions are weaker than interactions between polar groups. Therefore, although the filler effect is readily brought out on account of these interactions when toner strain is small, such interactions fail however to be brought out readily when toner strain is large, and hence the filler effect is hard to elicit. Accordingly, G′(1) and G′(50) can be set to lie in the above ranges.

Besides the above resins, various polymerizable monomers that are amenable to vinyl polymerization may be used concomitantly, as needed, in the vinyl resin.

Examples of such polymerizable monomers include the following.

Unsaturated monoolefins such as ethylene, propylene, butylene and isobutylene; unsaturated polyenes such as butadiene and isoprene; vinyl halides such as vinyl chloride, vinylidene chloride, vinyl bromide and vinyl fluoride; vinyl esters such as vinyl acetate, vinyl propionate and vinyl benzoate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinylnaphthalenes; as well as polymerizable monomers having a carboxy group, for instance unsaturated dibasic acids such as maleic acid, citraconic acid, itaconic acid, alkenylsuccinic acids, fumaric acid and mesaconic acid; unsaturated dibasic anhydrides such as maleic anhydride, citraconic anhydride, itaconic anhydride and alkenylsuccinic anhydrides; half esters of unsaturated dibasic acids such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half esters, methyl fumarate half ester and methyl mesaconate half ester; unsaturated dibasic acid esters such as maleic acid dimethyl ester and fumaric acid dimethyl ester; acid anhydrides of α,β-unsaturated acids such as acrylic acid, methacrylic acid, crotonic acid and cinnamic acid; anhydrides of these α,β-unsaturated acids and lower fatty acids; alkenyl malonic acids, alkenyl glutaric acids and alkenyl adipic acids; as well as acid anhydrides of the foregoing, and monoesters of the foregoing.

As the case may require, the vinyl resin may be a polymer crosslinked with a crosslinking polymerizable monomer such as those exemplified below.

Examples of the crosslinking polymerizable monomer include the following.

Aromatic divinyl compounds; diacrylate compounds having an alkyl chain bridge; diacrylate compounds having an alkyl chain bridge containing an ether bond; diacrylate compounds having a bridge of a chain containing an aromatic group and an ether bond; polyester-type diacrylates; and multifunctional crosslinking agents.

Examples of aromatic divinyl compounds include divinylbenzene and divinylnaphthalene.

Examples of the above diacrylate compounds having an alkyl chain bridge include ethylene glycol diacrylate, 1,3-butylene glycol diacrylate, 1,4-butanediol diacrylate, 1,5-pentanediol acrylate, 1,6-hexanediol diacrylate, neopentyl glycol diacrylate, and compounds resulting from replacing the acrylate in the foregoing compounds with methacrylate.

The vinyl resin is preferably a polymer of polymerizable monomers including at least one selected from the group consisting of styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, p-nitrostyrene, acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, acrylonitrile, methacrylonitrile, acrylamide, 2-hydroxyethyl acrylate, 2-hydroxyethyl methacrylate, 2-hydroxypropyl methacrylate, 4-(1-hydroxy-1-methylbutyl)styrene and 4-(1-hydroxy-1-methylhexyl)styrene.

The vinyl resin may be a copolymer of at least one polymerizable monomer selected from the above group, and a monomer including at least one crosslinking polymerizable monomer selected from the group consisting of divinylbenzene, divinylnaphthalene, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, ethylene glycol dimethacrylate, 1,3-butylene glycol dimethacrylate, 1,4-butanediol dimethacrylate, 1,5-pentanediol dimethacrylate, 1,6-hexanediol dimethacrylate and neopentyl glycol dimethacrylate. The content ratio of the crosslinking monomer among the monomers may be set to from about 0.5 mass % to 5.0 mass %.

The vinyl resin may be a resin produced using a polymerization initiator. From the viewpoint of efficiency, the polymerization initiator may be used in an amount from 0.05 parts by mass to 10.00 parts by mass relative to 100.00 parts by mass of the polymerizable monomers. Examples of the polymerization initiator include the following.

ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy)butane, tert-butylhydroperoxide, cumene hydroperoxide, 1,1,3,3-tetramethylbutylhydroperoxide, di-tert-butyl peroxide, tert-butylcumyl peroxide, dicumyl peroxide, a,a′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

The same vinyl resins and polyester resins used as the above-described amorphous resin can be utilized herein as the vinyl resin and polyester resin that are used to form a hybrid resin in which the vinyl resin and the polyester resin are bonded to each other.

Examples of the method for producing a hybrid resin in which a vinyl-based resin and a polyester resin are bonded to each other include for instance a polymerization method that utilizes a compound (hereafter “bireactive compound”) that can react with any of the monomers that generate both resins.

Bireactive compounds include compounds such as fumaric acid, acrylic acid, methacrylic acid, citraconic acid, maleic acid and dimethyl fumarate. Fumaric acid, acrylic acid and methacrylic acid are preferably used among the foregoing.

In a case where a hybrid resin is used in which a vinyl resin and a polyester resin are bonded to each other, the content ratio of the vinyl resin in the hybrid resin is preferably 10 mass % or more, 20 mass % or more, 40 mass % or more, 60 mass % or more or 80 mass % or more, and preferably 100 mass % or less, or 90 mass % or less.

From the viewpoint of charging stability, the acid value of the amorphous resin used as the binder resin of the present disclosure is preferably from 0 mgKOH/g to 100 mgKOH/g, more preferably from 10 mgKOH/g to 60 mgKOH/g, yet more preferably from 15 mgKOH/g to 50 mgKOH/g, and particularly preferably from 20 mgKOH/g to 30 mgKOH/g.

Similarly, the hydroxyl value is preferably from 0 mgKOH/g to 100 mgKOH/g, more preferably from 10 mgKOH/g to 75 mgKOH/g, yet more preferably from 15 mgKOH/g to 70 mgKOH/g, and particularly preferably from 18 mgKOH/g to 60 mgKOH/g.

The content ratio of a tetrahydrofuran (THF)-insoluble fraction of the binder resin is preferably from 0.1 mass % to 60.0 mass % referred to the mass of the binder resin. The THF-insoluble fraction of the binder resin is preferably used herein, by virtue of being softer than THF-insoluble fractions such as inorganic fine particles, and having little of an adverse effect on low-temperature fixability. When the content ratio of the THF-insoluble fraction of the binder resin lies within the above ranges, the toner tends to be superior in character reproducibility and dot reproducibility. Preferably, the content ratio is preferably from 1.0 mass % to 50.0 mass %, more preferably from 1.0 mass % to 40.0 mass % and yet more preferably from 5.0 mass % to 30.0 mass %. The THF-insoluble fraction may be a crystalline resin or an amorphous resin. From the viewpoint of hot offset property, the THF-insoluble fraction is preferably an amorphous resin. The content ratio of the THF-insoluble fraction of the binder resin can be controlled, for instance in the case of a polyester resin, in accordance with a method that involves using a trihydric or higher alcohol or acid, or a method that involves synthesizing an unsaturated polyester, followed by crosslinking using a polymerization initiator. In a case where the THF-insoluble fraction is a vinyl resin, the content ratio of the THF-insoluble fraction can be controlled in accordance with a method such as using the above above-described crosslinking monomer.

A method for measuring the amount and the content ratio of the THF-insoluble fraction of the binder resin will be described further on.

The binder resin comprised in the toner particle of the toner comprises a crystalline resin, and in a differential scanning calorimetry (DSC) measurement of the toner as a sample, a peak temperature of an endothermic peak corresponding to the crystalline resin, in a first temperature rise, is 50° C. to 70° C., and an endothermic quantity ΔH (J/g) of the endothermic peak satisfies ΔH≥5. The peak temperature of the endothermic peak is more preferably from 55° C. to 65° C. The endothermic quantity ΔH of the endothermic peak more preferably satisfies ΔH≥7, and yet more preferably satisfies ΔH≥10.

The fact that peak temperature of the endothermic peak corresponding to the crystalline resin, in the first temperature rise, is herein from 50° C. to 70° C., and the fact that the endothermic quantity of the endothermic peak satisfies herein ΔH≥5, are indications that the toner particle has a significant content of a crystalline resin component. This is preferable, since as a result the toner exhibits a sharp melt property, and improved low-temperature fixability. The above is also preferable since in that case the value of the storage elastic modulus G′(50) at 50% strain can be reduced.

The peak temperature of the endothermic peak corresponding to the crystalline resin and the endothermic quantity of the endothermic peak can be adjusted as appropriate by modifying the type of the monomers used as starting materials in the crystalline resin.

The content ratio of the tetrahydrofuran (THF)-insoluble fraction of the toner is preferably 12 mass % to 60 mass %, more preferably 13 mass % to 55 mass %, yet more preferably 15 mass % to 50 mass %, and particularly preferably 18 mass % to 45 mass %, on a toner mass basis. A method for measuring the amount and the content ratio of the THF-insoluble fraction of the toner will be described further on.

The THF-insoluble fraction of the toner obtained in accordance with the method described further on includes inorganic pigments and organic pigments contained as toner colorants, fine particles contained in the toner particle, fine particles used as an external additive, and the THF-insoluble fraction contained in the binder resin. Therefore, the content ratio of the THF-insoluble fraction of the toner can be adjusted by adjusting the content of the foregoing.

The amount of organic component in the THF-insoluble fraction of the toner is large when the content ratio of the THF-insoluble fraction of the toner lies within the above ranges. The organic component interacts strongly with the binder resin. As a result, even when a crystalline resin is used as the binder resin, the storage elastic modulus of the toner can be increased easily, and G′(1) and G′(50) can be set within the above ranges.

The content ratio of incineration ash of the tetrahydrofuran (THF)-insoluble fraction of the toner (hereafter simply referred to as incineration ash) is preferably 5 mass % to 30 mass %, more preferably 6 mass % to 23 mass % and yet more preferably 8 mass % to 20 mass %, on a toner mass basis. A method for measuring the content ratio of incineration ash will be described further on.

The solids of the toner, being herein the incineration ash of THF-insoluble fraction of the toner as obtained in accordance with the below-described method, are inorganic pigments and organic pigments contained as colorants in the toner, fine particles used as an external additive, as well as the inorganic component contained in the THF-insoluble fraction of the binder resin. Therefore, the content ratio of the incineration ash can be adjusted by adjusting the content of the foregoing.

At the time of toner melting the inorganic component interacts with resins more weakly than the organic component does. This results in a weaker filler effect when the toner is under significant strain. In consequence, the change in the storage elastic modulus measured by modifying toner strain increases readily, and G′(1) and G′(50) can be set within the above ranges.

The content of incineration ash in the tetrahydrofuran (THF)-insoluble fraction of the toner is preferably from 24 mass % to 85 mass %, more preferably from 26 mass % to 77 mass %, yet more preferably from 30 mass % to 70 mass %, and particularly preferably from 35 mass % to 65 mass %, relative to the content ratio of the THF-insoluble fraction of the toner.

As described above, the content ratio of incineration ash relative to the content ratio of the THF-insoluble fraction of the toner denotes herein the proportion of an inorganic component in the THF-insoluble fraction of the toner. Conversely, a component other than the incineration ash in the THF-insoluble fraction of the toner can be regarded as an organic component. Also the organic component in the THF-insoluble fraction of the toner acts as a filler at the time of toner melting, similarly to the inorganic component. However, the organic component in the THF-insoluble fraction of the toner interacts strongly with the binder resin, and accordingly elicits a stronger filler effect than the inorganic component, when strain is low.

That is, by setting the content ratio of the incineration ash relative to the content ratio of the THF-insoluble fraction of the toner so as to lie within the above ranges, it becomes possible to combine an organic component that elicits a strong filler effect at low strain and an inorganic incineration ash that elicits a weak filler effect at high strain. As a result, G′(1) and G′(50) can be set within the above ranges.

Preferably, the binder resin comprised in the toner comprises a crystalline resin and an amorphous resin, and in cross-sectional observation of the toner particle using a transmission electron microscope, the binder resin has a domain-matrix structure made up of a matrix comprising the crystalline resin and domains comprising the amorphous resin.

Excellent low-temperature fixability is brought out thanks to the presence of a crystalline resin in the matrix. By virtue of the presence of the amorphous resin in domains, moreover, the amorphous resin domains act as a filler. Changes in storage elastic modulus with strain are brought out more readily due to the fact that the toner particle has a domain-matrix structure. A toner excellent in low-temperature fixability, character reproducibility and dot reproducibility can be obtained as a result.

The toner particle can exhibit a domain-matrix structure through appropriate modification of the composition of the crystalline resin and of the amorphous resin.

Furthermore, the number-average diameter of the domains is preferably from 0.05 μm to 3.00 μm, more preferably from 0.10 μm to 2.00 μm, and yet more preferably from 0.10 μm to 1.00 μm. Preferably, the number-average diameter of the domains lies within the above range, since in that case the amorphous resin readily acts as a filler at the time of toner melting, and changes in storage elastic modulus with strain are brought out more readily. A toner excellent in low-temperature fixability, character reproducibility and dot reproducibility can be obtained as a result.

The number-average diameter of the domains can be controlled for instance on the basis of the composition of the monomers that make up the crystalline resin, the composition of the monomers that make up the amorphous resin, and the production conditions of the toner particles.

In a cross-sectional observation of the toner particle, the proportion of the surface area of the domains relative to the surface area of a cross section of the toner particle (hereafter also simply referred to as the area ratio of the domains) is preferably from 15% to 80%, more preferably from 20% to 70%, yet more preferably from 30% to 65%, and particularly preferably from 38% to 61%.

In the viscoelasticity measurement in which the strain in the molded sample is caused to vary, at 90° C., the storage elastic modulus G′(1) of the molded sample at 1% strain and a loss elastic modulus G″(1) of the molded sample at 1% strain satisfy G′(1)>G″(1).

Satisfying G′(1)>G″(1) signifies herein that the elastic term is larger than the viscous term when the strain is small in the viscoelasticity measurement of the molded sample, and that the toner behaves thus elastically. This is preferable since, as a result, deformation is reduced at a stage preceding a large application of pressure in the fixing process, and the reproducibility of characters and dots is thus further improved.

Means for achieving a toner viscoelasticity obeying G′(1)>G″(1) involve modifying the composition of the monomers that make up the crystalline resin, the composition of the monomers that make up the amorphous resin, and the type and amount of the filler component included in the toner particle.

The second aspect of the present disclosure relates to a toner, comprising a toner particle comprising a binder resin,
wherein the binder resin comprises a crystalline resin;
the crystalline resin is a crystalline vinyl resin
   having at least first monomer units represented by Formula (1); and
   having at least two of monomer units selected from the group consisting of second monomer units represented by Formula (2), or
   having second monomer units represented by Formula (2) and third monomer units represented by Formula (3); and
a content ratio of an incineration ash of a tetrahydrofuran-insoluble fraction of the toner is 5 to 30 mass % based on a mass of the toner:

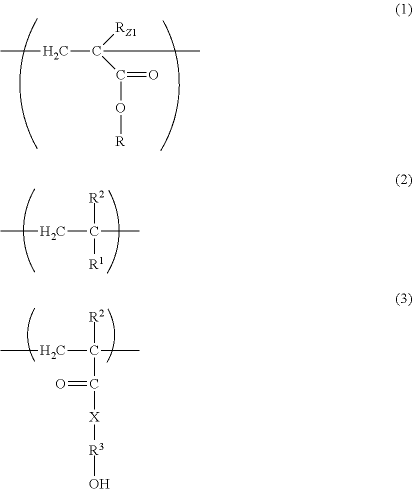

in Formula (1), R_{z1} represents a hydrogen atom or a methyl group, and R represents an alkyl group having 18 to 36 carbon atoms;
in Formula (2), R¹ is —C≡N,
—C(═O)NHR¹⁰ (where R¹⁰ represents a hydrogen atom or an alkyl group having 1 to 4 carbon atoms),
a hydroxy group,
—COOR¹¹ (where R¹¹ represents a hydrogen atom or an alkyl group having 1 to 6 carbon atoms), or
—NH—C(═O)—N(R¹³)₂ (where the two R¹³ represent each independently a hydrogen atom or an alkyl group having 1 to 6 carbon atoms), and
R² represents a hydrogen atom or a methyl group; and in Formula (3), X represents 0 or NH, R² represents a hydrogen atom or a methyl group, and R³ represents an alkylene having 2 to 6 carbon atoms.

A second aspect of the present disclosure will be explained next.

The toner of the second aspect comprises a toner particle. The toner particle comprises a binder resin. The binder resin comprises a crystalline resin. The crystalline resin is a crystalline vinyl resin and has first monomer units represented by Formula (1) below.

Preferably, the content ratio of the first monomer units in the crystalline vinyl resin is from 20.0 mass % to 100.0 mass %, since in that case the vinyl resin has crystallinity, and readily combines low-temperature fixability and hot offset resistance.

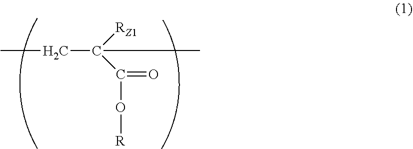

In Formula (1), R_{z1} represents a hydrogen atom or a methyl group, and R represents an alkyl group having 18 to 36 carbon atoms. R is preferably an alkyl group having 18 to 30 carbon atoms. The alkyl group preferably has a linear structure.

The first monomer units have an alkyl group having 18 to 36 carbon atoms represented by R, in a side chain, such that the crystalline vinyl resin readily develops crystallinity by virtue of having such a moiety.

In a case where the content ratio of the first monomer units in the crystalline vinyl resin is less than 20.0 mass %, crystallinity does not develop readily, and the low-temperature fixability is prone to drop. The content ratio of the first monomer units in the crystalline vinyl resin is preferably 40.0 mass % or more, and more preferably 50.0 mass % or more. The upper limit is not particularly restricted, but is preferably 90.0 mass % or less, more preferably 80.0 mass % or less.

Crystalline vinyl resins exhibit superior charge retention properties in high-temperature, high-humidity environments, as compared with conventionally known crystalline polyesters which are crystalline resins, possibly due to the fact that side chains of crystalline vinyl resins have a crystalline structure.

The first monomer units represented by Formula (1) in the second aspect can be suitably used for reasons similar to those expounded in the first aspect; the polymerizable monomers that form the first monomer units in the second aspect can suitably be used for similar reasons to those expounded in the first aspect.

The crystalline resin of the second aspect has at least two of monomer units selected from the group consisting of second monomer units represented by Formula (2) (hereafter also simply referred to as second monomer units); alternatively, the crystalline resin of the second aspect has second monomer units and third monomer units represented by Formula (3) (hereafter also simply referred to as third monomer units). Preferably, the crystalline resin of the second aspect has second monomer units represented by Formula (2) and third monomer units represented by Formula (3).

The second monomer units have a polar group directly attached to the main chain of the crystalline vinyl resin. The third monomer units have an alkylene having 2 to 6 carbon atoms group between the main chain of the crystalline vinyl resin and a hydroxy group, such that a polar hydroxy group is present spaced from the main chain.

By having at least two of monomer units selected from the group consisting of the second monomer units, or by having the second monomer units and the third monomer units, the toner exhibits, when melting, a higher viscosity than that when these monomer units are absent. This derives from electric dipole interactions between polar groups in the crystalline vinyl resin.

In the second monomer units a polar functional group is directly bonded to the main chain that contributes significantly to molecular mobility. After toner melting, therefore, the storage elastic modulus is higher than that of a crystalline vinyl resin having no polar groups directly bonded to the main chain of the resin.

Deformation of the toner can be minimized thanks to the effect of the second monomer unit, at a stage in the fixing process where only heat is received from the fixing member.

By contrast, the third monomer units have a polar hydroxy group at a position spaced from the main chain. After toner melting, therefore, the storage elastic modulus increases less readily than in a crystalline vinyl resin having polar groups directly bonded to the main chain of the resin.

In a case where second monomer units and the third monomer units are co-present it is considered that part of the polar groups of the third monomer units interact with the polar groups of the second monomer units, when toner strain is small. In this case deformation of the toner can be minimized, by virtue of the above-described effect of the second monomer units, at the stage where the toner is acted upon by only heat from the fixing member.

It is further found that upon application of pressure from the fixing member, interactions between the polar groups of the third monomer units and the polar groups of the second monomer units are reduced, and molecular mobility is increased, which translates into lower toner viscosity. That is, the storage elastic modulus can be caused to vary significantly between that when the toner is acted upon by heat alone, and that when the toner is acted upon by an external force, together with heat. As a result, low-temperature fixability, character reproducibility, and dot reproducibility can all be achieved at a high level.

A content ratio W2 of the second monomer units in the crystalline vinyl resin is preferably 1.0 mass % or more, and more preferably 5.0 mass % or more. The content ratio W2 is preferably 70.0 mass % or less, more preferably 30.0 mass % or less, and yet more preferably 20.0 mass % or less.

The content ratio W3 of the third monomer units in the crystalline vinyl resin is preferably 1.0 mass % or more, and more preferably 5.0 mass % or more. The content ratio W3 is preferably 70.0 mass % or less, more preferably 30.0 mass % or less, and yet more preferably 20.0 mass % or less.

A ratio of the content ratios W2/W3 of the second monomer units and the third monomer units ranges preferably from 0.1 to 10.0, and yet more preferably from 0.5 to 5.0.

The monomers exemplified in the first aspect can be suitably used, for similar reasons, as the polymerizable monomers that form the second monomer units and the third monomer units.

The crystalline resin of the toner of the second aspect may contain, as needed, monomer units other than the first, second and third monomer units, so long as the effects of the present disclosure are not impaired thereby. The monomers exemplified in the first aspect can be suitably used, for similar reasons, as the polymerizable monomers that form the monomer units other than the first, second and third monomer units.

The content ratios of monomer units other than the first, second and third monomer units in the crystalline resin is preferably 50 mass % or less, more preferably 40 mass % or less.

In the toner of the second aspect, the content of incineration ash of the tetrahydrofuran (THF)-insoluble fraction (hereafter simply referred to as incineration ash) of the toner is 5 mass % to 30 mass % on a mass of the toner. The content ratio of the incineration ash is preferably 6 mass % to 23 mass %, and more preferably 8 mass % to 20 mass %. A method for measuring the content ratio of incineration ash will be described below.

The solids of the toner, being herein the incineration ash of THF-insoluble fraction of the toner as obtained in accordance with the below-described method, are inorganic pigments and organic pigments contained as colorants in the toner, fine particles used as an external additive, as well as the inorganic component contained in the THF-insoluble fraction of the binder resin. Therefore, the content ratio of the incineration ash can be adjusted by adjusting the content of the foregoing.

At the time of toner melting the inorganic component interacts with resins more weakly than the organic component does. This results in a weaker filler effect when the toner is under significant strain. In consequence, the toner does not melt readily on account of the filler effect when not acted upon by pressure from the fixing member in the fixing process, and melting of the toner progress due to the fact that the toner is acted upon by pressure from the fixing member. As a result it becomes possible to combine character reproducibility, dot reproducibility and low-temperature fixability at a high level.

In the toner of the second aspect, for the same reasons as in the toner of the first aspect, the content ratio of the tetrahydrofuran (THF)-insoluble fraction of the binder resin is preferably from 0.1 mass % to 60.0 mass %, more preferably from 1.0 mass % to 50.0 mass %, yet more preferably from 1.0 mass % to 40.0 mass %, and particularly preferably from 5.0 mass % to 30.0 mass %, relative to the mass of the binder resin.

The content ratio of the tetrahydrofuran (THF)-insoluble fraction of the toner of the second aspect is preferably from 12 mass % to 60 mass %, more preferably from 13 mass % to 55 mass %, yet more preferably from 15 mass % to 50 mass %, and particularly preferably from 18 mass % to 45 mass %, on a toner mass basis. A method for measuring the amount and the content ratio of the THF-insoluble fraction of the toner will be described further on.

The THF-insoluble fraction of the toner obtained in accordance with the method described further on includes inorganic pigments and organic pigments contained as toner colorants, fine particles contained in the toner particle, fine particles used as an external additive, and the THF-insoluble fraction of the binder resin. Therefore, the content ratio of the THF-insoluble fraction of the toner can be adjusted by adjusting the contents of the foregoing.

The amount of organic component in the THF-insoluble fraction of the toner is large when the content of the THF-insoluble fraction of the toner lies within the above ranges. The organic component interacts strongly with the binder resin. The filler effect is therefore strongly brought out at low strain.

As a result it becomes possible to combine character reproducibility, dot reproducibility and low-temperature fixability at a high level.

The content ratio of the incineration ash of the tetrahydrofuran (THF)-insoluble fraction of the toner of the second aspect is preferably from 24 mass % to 85 mass %, more preferably from 26 mass % to 77 mass %, yet more preferably from 30 mass % to 70 mass %, and particularly preferably from 35 mass % to 65 mass %, relative to the content ratio of the THF-insoluble fraction of the toner.

As described above, the content ratio of incineration ash relative to the content ratio of the THF-insoluble fraction of the toner denotes herein the proportion of inorganic component in the THF-insoluble fraction of the toner. Conversely, a component other than the incineration ash in the THF-insoluble fraction of the toner can be regarded as an organic component. Also the organic component in the THF-insoluble fraction of the toner acts as a filler at the time of toner melting, similarly to the inorganic component. However, the organic component in the THF-insoluble fraction of the toner interacts strongly with the binder resin, and accordingly elicits a stronger filler effect than the inorganic component, when strain is low.

That is, by setting the proportion of the incineration ash relative to the content ratio of the THF-insoluble fraction of the toner so as to lie within the above ranges it becomes possible to combine an organic component that elicits a strong filler effect at low strain and an inorganic incineration ash that elicits a weak filler effect at high strain. As a result character reproducibility, dot reproducibility and low-temperature fixability can be combined at a high level.

The toner of the second aspect preferably further contains an amorphous resin as the binder resin. Amorphous resins exemplified in the first aspect can be suitably used, for similar reasons, as the amorphous resin in the second aspect.

For the same reasons as in the toner of the first aspect, the toner of the second aspect preferably has a domain-matrix structure made up of a matrix containing the crystalline resin and domains containing the amorphous resin, in cross-sectional observation of the toner particle using a transmission electron microscope.

For the same reasons as in the toner of the first aspect, the number-average diameter of the domains is preferably from 0.05 μm to 3.00 more preferably from 0.10 μm to 2.00 and yet more preferably from 0.10 μm to 1.00 μm.

The toner of the second aspect preferably exhibits a ratio (hereafter also simply referred to as domain area ratio) of the surface area of the domains relative to the surface area of a cross section of the toner particle, in the range from 15% to 80%, in a cross-sectional observation of the toner.

In the toner of the second aspect, for the same reasons as in the toner of the first aspect, the storage elastic modulus G′(1) of the toner at 1% strain and the loss elastic modulus G″(1) of the toner at 1% strain, as obtained in a viscoelasticity measurement in which toner strain is caused to vary, at 90° C., satisfies the relationship G′(1)>G″(1).

Features common to the first aspect and second aspect of the present disclosure will be explained next.

So long as the effect of the present disclosure is not impaired thereby, the binder resin may contain a resin other than the above crystalline resin and amorphous resin, for instance for the purpose of improving pigment dispersibility.

Examples of such a resin include the following.

Polyvinyl chloride, phenolic resins, natural resin-modified phenolic resins, natural resin-modified maleic acid resins, polyvinyl acetate, silicone resins, polyester resins, polyurethane resins, polyamide resins, furan resins, epoxy resins, xylene resins, polyvinyl butyral, terpene resins, coumarone-indene resins and petroleum-based resins.

The toner particle may contain a colorant. Examples of the colorant include those listed below. Examples of black colorants include carbon black; and materials that are colored black through use of yellow colorants, magenta colorants and cyan colorants. The colorant may be a single pigment, but using a colorant obtained by combining a dye and a pigment and improving the clarity is more preferred from the perspective of full color image quality.

Examples of a pigment for a magenta toner include the following.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C. I. Pigment Violet 19; C. I. Vat Red 1, 2, 10, 13, 15, 23, 29, 35.

Examples of a dye for a magenta toner include the following.

Oil-soluble dyes such as C. I. Solvent Red 1, 3, 8, 23, 24, 25, 27, 30, 49, 81, 82, 83, 84, 100, 109, 121; C. I. Disperse Red 9; C. I. Solvent Violet 8, 13, 14, 21, 27; C. I. Disperse Violet 1, Basic dyes such as C. I. Basic Red 1, 2, 9, 12, 13, 14, 15, 17, 18, 22, 23, 24, 27, 29, 32, 34, 35, 36, 37, 38, 39, 40; C. I. Basic Violet 1, 3, 7, 10, 14, 15, 21, 25, 26, 27, 28.

Examples of a pigment for a cyan toner include the following.

C. I. Pigment Blue 2, 3, 15:2, 15:3, 15:4, 16, 17; C. I. Vat Blue 6; C. I. Acid Blue 45, a copper phthalocyanine pigment having a phthalocyanine skeleton substituted with 1 to 5 phthalimidomethyl groups.

Examples of a dye for a cyan toner include C. I. Solvent Blue 70.

Examples of a pigment for a yellow toner include the following.

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C. I. Vat Yellow 1, 3, 20.

Examples of a dye for a yellow toner include C. I. Solvent Yellow 162.

The content of the colorant is preferably from 0.1 part by mass to 30.0 parts by mass, more preferably from 0.1 part by mass to 20.0 parts by mass, relative to 100.0 parts by mass of the binder resin. The viscoelasticity of the present disclosure can be readily brought out by setting the content of colorant to lie in the above ranges.

In a case where a pigment is used as the colorant, the number-average diameter of primary particles of the pigment is preferably from 30 nm to 300 nm, and more preferably from 40 nm to 200 nm. Within the above ranges, the change in storage elastic modulus becomes readily larger when viscoelasticity is measured through a change in strain. The number-average diameter of the primary particles of the pigment can be measured by resorting to a known means, for instance using a scanning electron microscope.

The toner particle preferably contains a wax. Examples of the wax include those listed below. Hydrocarbon-based waxes such as microcrystalline waxes, paraffin waxes and Fischer Tropsch waxes; oxides of hydrocarbon-based waxes, such as oxidized polyethylene waxes, and block copolymers thereof; waxes comprising mainly fatty acid esters, such as carnauba wax; and waxes obtained by partially or wholly deoxidizing fatty acid esters, such as deoxidized carnauba wax.

Further examples include the types listed below. Saturated straight chain fatty acids such as palmitic acid, stearic acid and montanic acid; unsaturated fatty acids such as brassidic acid, eleostearic acid and parinaric acid; saturated alcohols such as stearyl alcohol, aralkyl alcohols, behenyl alcohol, carnaubyl alcohol, ceryl alcohol and melissyl alcohol; polyhydric alcohols such as sorbitol; esters of fatty acids such as palmitic acid, stearic acid, behenic acid and montanic acid and alcohols such as stearyl alcohol, aralkyl alcohols, behenyl alcohol, carnaubyl alcohol, ceryl alcohol and melissyl alcohol; fatty acid amides such as linoleic acid amide, oleic acid amide and lauric acid amide; saturated fatty acid bisamides such as methylene bis-stearic acid amide, ethylene bis-capric acid amide, ethylene bis-lauric acid amide and hexamethylene bis-stearic acid amide; unsaturated fatty acid amides such as ethylene bis-oleic acid amide, hexamethylene bis-oleic acid amide, N,N′-dioleyladipic acid amide and N,N′-dioleylsebacic acid amide; aromatic bisamides such as m-xylene bis-stearic acid amide and N,N′-distearylisophthalic acid amide; fatty acid metal salts (commonly known as metal soaps) such as calcium stearate, calcium laurate, zinc stearate and magnesium stearate; waxes obtained by grafting vinyl monomers such as styrene and acrylic acid onto aliphatic hydrocarbon-based waxes; partial esters of fatty acids and polyhydric alcohols, such as behenic acid monoglyceride; and hydroxyl group-containing methyl ester compounds obtained by hydrogenating plant-based oils and fats.

The content of the wax is preferably 2.0 to 30.0 parts by mass relative to 100.0 parts by mass of the binder resin.

The toner particle may contain a charge control agent if necessary. A well-known charge control agent can be used, but an aromatic carboxylic acid metal compound is particularly preferred from the perspectives of being colorless, toner charging speed being rapid, and being able to stably maintain a certain degree of charge quantity.

Examples of negative type charge control agents include metal salicylate compounds, metal naphthoate compounds, metal dicarboxylate compounds, polymer type compounds having a sulfonic acid or carboxylic acid in a side chain, polymer type compounds having a sulfonic acid salt or sulfonic acid ester in a side chain, polymer type compounds having a carboxylic acid salt or carboxylic acid ester in a side chain, boron compounds, urea compounds, silicon compounds and calixarenes.

The charge control agent may be internally or externally added to the toner particle. The content of the charge control agent is preferably 0.2 to 10.0 parts by mass relative to 100.0 parts by mass of the binder resin.

The toner can also contain inorganic fine particles, as needed. The inorganic fine particles may be added internally to the toner particle, or may be mixed with the toner particle as an external additive. In particular, through internal addition to the toner particle it becomes possible to readily control changes in storage elastic modulus based on the magnitude of strain, and to combine low-temperature fixability, character reproducibility and dot reproducibility.

Silica, titanium oxide, aluminum oxide, metal titanates such as strontium titanate and calcium titanate, and calcium carbonate are preferred herein as the inorganic fine particles that are internally added to the toner particle.

The number-average diameter of the primary particles of the inorganic fine particles that are internally added to the toner particle is preferably from 40 nm to 800 nm, more preferably from 80 nm to 600 nm, yet more preferably from 100 nm to 500 nm, and particularly preferably from 150 nm to 450 nm. Within the above range, the change in storage elastic modulus becomes readily larger when viscoelasticity is measured through a change in strain. The number-average diameter of the primary particles of the inorganic fine particles can be measured by resorting to a known means, for instance using a scanning electron microscope.

The toner may contain an external additive other than the above inorganic fine particles. For instance, the toner may be obtained through external addition of an external additive to the toner particle. Inorganic fine particles such as silica, titanium oxide, aluminum oxide, or metal titanates are preferable herein as the external additive. The inorganic fine particles used as the external additive are preferably hydrophobized with a hydrophobic agent such as a silane compound, silicone oil, or a mixture thereof.

Inorganic fine particles having a BET specific surface area from 50 m²/g to 400 m²/g are preferred as an external additive for improving flowability; herein inorganic fine particles having a BET specific surface area from 10 m²/g to 50 m²/g are preferred, for the purpose of stabilizing durability. Inorganic fine particles having a BET specific surface area within the above ranges may be used concomitantly, with a view to improving flowability and stabilize durability. A known mixer such as a Henschel mixer can be used for mixing the toner particle and the external additive.

The total content ratio of the inorganic fine particles contained in the toner particle and the inorganic fine particles that are externally added to the toner particle is preferably from 0.1 mass % to 30.0 mass % with respect to the toner particle.

The toner can be used as a one-component developer, but is preferably mixed with a magnetic carrier and used as a two-component developer, in terms of obtaining stable images over long periods of time. Specifically, the developer is herein a two-component developer containing a toner and a magnetic carrier, such that the toner is the above-described toner.

Examples of magnetic carriers include generally known ones such as an iron powder or a surface-oxidized iron powder; metal particles of iron, lithium, calcium, magnesium, nickel, copper, zinc, cobalt, manganese, chromium, rare earths or the like, as well as alloy particles thereof and oxide particles thereof; magnetic bodies such as ferrite; and magnetic body-dispersed resin carriers (so-called resin carriers) containing one such magnetic body and a binder resin that holds the magnetic body in a dispersed state.

In a case where the toner is mixed with a magnetic carrier and used as a two-component developer, the content ratio of the toner in the two-component developer is preferably from 2 mass % to 15 mass %, more preferably from 4 mass % to 13 mass %.

The method for producing a toner particle is not particularly limited, and conventionally known production methods such as a suspension polymerization method, an emulsion aggregation method, a melt-kneading method or a dissolution suspension method can be resorted to.

A melt-kneading method will be explained below as an example, but the method is not limited thereto.

Firstly, in a starting material mixing step, a crystalline resin and an amorphous resin, or a binder resin containing a crystalline resin and an amorphous resin, as materials the that make up the toner particle, and as needed other components such as a wax, a colorant and a charge control agent, are weighed in predetermined amounts, and are blended and mixed. Examples of mixing devices include a double-cone mixer, a V-type mixer, a drum-type mixer, a super mixer, a Henschel mixer, a Nauta mixer and Mechano Hybrid (by Nippon Coke & Engineering Co., Ltd.).

The mixed materials are then melt-kneaded, to disperse the other components in the binder resin containing the crystalline resin and the amorphous resin. A batch kneader such as a pressure kneader or Banbury mixer, or a continuous kneader, can be used in the melt-kneading step; herein, single-screw and twin-screw extruders have become mainstream extruders on account of their superiority in terms of allowing for continuous production. Specific examples include a KTK model twin-screw extruder (by Kobe Steel, Ltd.), a TEM model twin-screw extruder (by Toshiba Machine Co., Ltd.), PCM kneader (by Ikegai Corp.), a twin-screw extruder (by KCK Co.), Ko-kneader (by Buss AG) and Kneadex (by Nippon Coke & Engineering Co., Ltd.). The resin composition obtained by melt-kneading may then be rolled using for instance two rolls, and may be cooled for instance with water in a cooling step.

For example, the dispersion state of the crystalline resin and the amorphous resin and the number-average diameter of the domains can be controlled for instance on the basis of the kneading temperature and the screw rotational speed in the melt-kneading step.

A mixture of a crystalline resin and an uncrosslinked amorphous resin may be crosslinked by means of a polymerization initiator, while the mixture is kneaded. Doing so allows controlling the amount and content ratio of the THF-insoluble fraction of the binder resin while enhancing the dispersion state of the crystalline resin and the amorphous resin.

Prior to production of the toner it is effective to carry out beforehand a method that involves crosslinking the uncrosslinked amorphous resin by means of a polymerization initiator, while kneading a mixture of the crystalline resin and the amorphous resin; a method that involves dissolving the crystalline resin and the uncrosslinked amorphous resin in a solvent, adding the polymerization initiator, while under stirring, and conducting the crosslinking reaction in a system where the crystalline resin and the amorphous resin are co-present; or a method that involves micro-dispersing the amorphous resin in the crystalline resin.

The cooled resin composition is then pulverized to a desired particle diameter in a pulverization step. In the pulverization step the resulting product is coarsely pulverized using a pulverizer such as a crusher, hammer mill or feather mill, and is thereafter finely pulverized using for instance a Kryptron system (by Kawasaki Heavy Industries, Ltd.), Super Rotor (by Nisshin Engineering Inc.) or Turbo Mill (by Freund-Turbo Corporation), or a pulverizer using an air jet system.

A toner particle may be then obtained thereafter through classification, as needed, classification using a sieving or classifying apparatus such as Elbow Jet (by Nittetsu Mining Co., Ltd.) which is an inertial classification system, or Turboplex (by Hosokawa Micron Corporation), TSP Separator (by Hosokawa Micron Corporation) or Faculty (by Hosokawa Micron Corporation) that rely on centrifugal classification.

Methods for measuring various physical properties of toner and starting materials will be described below.

Measurement of Viscoelasticity through Changes in the Strain of a Molded Sample

The measuring device used herein is a rotating-plate rheometer “ARES” (by TA Instruments Inc.). The measurement sample that is used is a molded sample obtained by weighing 0.1 g of toner and by compression molding of the toner for 60 seconds at 10 MPa, to yield a disc shape having a diameter of 8.0 mm and a thickness of 1.5±0.3 mm, using a tablet compression molder under an environment at room temperature (25° C.).

The molded sample is mounted on a parallel plate having a diameter of 8.0 mm, is heated from room temperature (25° C.) to 90° C. over 5 minutes, the temperature is held for 10 minutes, and the sample is then measured. The sample is set at this time so that the initial normal force is 0. As described below, the influence of the normal force in subsequent measurements can be canceled by turning on an automatic tension adjustment (Auto Tension Adjustment ON).

Measurements are performed under the following conditions.
(1) A parallel plate with a diameter of 8.0 mm is used herein.
(2) Frequency: 1 Hz.
(3) Strain is measured at six points of 0.1%, 1%, 5%, 10%, 50% and 100%, in a strain sweep mode. The measurement is performed under the following setting conditions of an automatic adjustment mode.
(4) Setting of maximum torque (Max Allowed Torque) to 200.0 [g·cm], and setting of minimum torque (Min Allowed Torque) to 0.2 [g·cm].
(5) Setting of automatic tension direction (Auto Tension Direction) to (Compression).
(6) Setting of (Initial Static Force) to 10 g and automatic tension sensitivity (Auto Tension Sensitivity) to 10.0 g.
(7) Setting of automatic tension (Auto Tension) operating conditions to (Sample Modulus): 1.00×10⁶ Pa or higher.

Under the above conditions there are measured the storage elastic modulus G′(1) of the molded sample at 1% strain, the loss elastic modulus G″(1) of the molded sample at 1% strain, and the storage elastic modulus G′(50) of the molded sample at 50% strain, for a measurement at a temperature of 90° C. and a frequency of 1 Hz.

Calculation of the Content Ratio of the THF-Insoluble Fraction in the Toner or Binder Resin, and Calculation of the Content Ratio of Incineration Ash

Herein 1.0 g of the toner for measuring the content and content ratio of the THF-insoluble fraction (0.7 g when measuring the THF-insoluble fraction of resin alone) is weighed exactly (w1 (g)), and is placed is on cylindrical filter paper (product name: No. 86R, size 28×100 mm, by Toyo Roshi Kaisha Ltd.), which is then set in a Soxhlet extractor.

Extraction is then performed for 18 hours using 200 mL of tetrahydrofuran (THF) as a solvent; extraction is conducted herein at a reflux rate such that there is one solvent extraction cycle is about once every 5 minutes.

Once extraction is over, the cylindrical filter paper is retrieved and air-dried, and is then vacuum-dried at 40° C. for 8 hours; thereupon, the mass of the cylindrical filter paper containing an extraction residue is weighed, and the mass of the extraction residue (w2 (g)) is calculated through subtraction of the mass of the cylindrical filter paper.

Then w2/w1 is calculated, to yield the content ratio of the THF-insoluble fraction of the toner or the binder resin.

An incineration ash amount w3 (g) in the THF-insoluble fraction is worked out as follows.

Cylindrical filter paper containing the above extraction residue is placed on a 30 mL magnetic crucible having been weighed beforehand.

The magnetic crucible is placed in an electric furnace, is heated at about 900° C. for about 3 hours, is allowed to cool in the electric furnace, is allowed to cool in a desiccator at normal temperature for 1 hour or longer, and the mass of the crucible containing the incineration ash fraction is weighed, whereupon the incineration ash amount (w3 (g)) is calculated through subtraction of the mass of the crucible and the mass of the cylindrical filter paper.

The content ratio of the incineration ash of the THF-insoluble fraction is calculated on the basis of w3/w2.

Method for Measuring the Acid Value of the Crystalline Resin and the Amorphous Resin

The acid value is the number of mg of potassium hydroxide required for neutralizing the acid contained in 1 g of sample. The acid values of the crystalline resin and the amorphous resin are measured in accordance with JIS K 0070-1992, specifically according to the following procedure.

(1) Preparation of reagents

Herein 1.0 g of phenolphthalein is dissolved in 90 mL of ethyl alcohol (95 vol %), and ion-exchanged water is added up to 100 mL, to yield a phenolphthalein solution. Meanwhile 7 g of special-grade potassium hydroxide are dissolved in 5 mL of water, and ethyl alcohol (95 vol %) is added up to 1 L. The resulting solution is placed in an alkali-resistant container, so as to preclude contact with carbon dioxide gas, and is allowed to stand for 3 days, followed by filtration, to yield a potassium hydroxide solution. The obtained potassium hydroxide solution is stored in an alkali-resistant container. To work out the factor of the potassium hydroxide solution, 25 mL of 0.1 mol/L hydrochloric acid are placed in an Erlenmeyer flask, several drops of the phenolphthalein solution are added, and titration is carried out using the above potassium hydroxide solution, the factor being then worked out on the basis of the amount of the above potassium hydroxide solution necessary for neutralization. Hydrochloric acid prepared in accordance with JIS K 8001-1998 is used as the above 0.1 mol/L hydrochloric acid.

(2) Operation

(A) Main test

Herein 2.0 g of a sample of pulverized crystalline resin or amorphous resin are weighed exactly in a 200 mL Erlenmeyer flask; followed by addition of 100 mL of a toluene/ethanol (2:1) mixed solution, and subsequent dissolution over 5 hours. A few drops of the above phenolphthalein solution are added next as an indicator, and titration is performed using the above potassium hydroxide solution. The end point of the titration occurs when the pale red color of the indicator persists for about 30 seconds.

(B) Blank test

Titration is performed in the same way as above but herein no sample is used (i.e. only a mixed solution of toluene/ethanol (2:1) is used).

(3) The acid value is then calculated by plugging the obtained results into the expression below.

A=[(C−B)×f×5.61]/S

In the expression, A: acid value (mgKOH/g), B: addition amount (mL) of the potassium hydroxide solution in the blank test, C: addition amount (mL) of the potassium hydroxide solution in the main test, f: factor of the potassium hydroxide solution, and S: mass (g) of the sample.

Method for Measuring the Hydroxyl Value of the Crystalline Resin and the Amorphous Resin

The hydroxyl value is the number of mg of potassium hydroxide necessary for neutralizing acetic acid bound to a hydroxyl group at the time of acetylation of 1 g of sample. The hydroxyl value is measured according to JIS K 0070-1992, specifically in accordance with the following procedure.

(1) Preparation of reagents

Herein 25 g of special-grade acetic anhydride are placed in a 100 mL volumetric flask, and pyridine is added to make up a total of 100 mL, with thorough shaking, to yield an acetylation reagent. The obtained acetylation reagent is stored in a brown bottle, so as not to come into contact for instance with moisture or carbon dioxide gas.

Then 1.0 g of phenolphthalein is dissolved in 90 mL of ethyl alcohol (95 vol %), with addition of ion-exchanged water up to 100 mL, to yield a phenolphthalein solution.

Meanwhile, 35 g of special-grade potassium hydroxide are dissolved in 20 mL of water, and ethyl alcohol (95 vol %) is added up to 1 L. The resulting solution is placed in an alkali-resistant container, so as to preclude contact with carbon dioxide gas and so forth, and is allowed to stand for 3 days, followed by filtration, to yield a potassium hydroxide solution. The obtained potassium hydroxide solution is stored in an alkali-resistant container. To work out the factor of the potassium hydroxide solution, 25 mL of 0.5 mol/L hydrochloric acid are placed in an Erlenmeyer flask, several drops of a phenolphthalein solution are added, and titration is carried out using the above potassium hydroxide solution, the factor being then worked out on the basis of the amount of the potassium hydroxide solution necessary for neutralization. Hydrochloric acid prepared in accordance with JIS K 8001-1998 is used as the above 0.5 mol/L hydrochloric acid.

(2) Operation

(A) Main test

Herein 1.0 g of a sample of pulverized crystalline resin or amorphous resin is weighed exactly in a 200 mL round bottom flask, and 5.0 mL of the above acetylation reagent are accurately added thereto, using a whole pipette. If the sample proves herein difficult to dissolve in the acetylation reagent, a small amount of special-grade toluene is added, to dissolve the sample.

A small funnel is placed on the mouth of the flask, and about 1 cm of the bottom of the flask is heated by being immersed in a glycerin bath at about 97° C. In order to prevent the temperature of the neck of the flask from rising by absorbing heat from the bath, it is preferable to cover the base of the neck of the flask with heavy paper having a round hole opened therein.

After 1 hour the flask is removed from the glycerin bath and is allowed to cool down. After cool-down, 1 mL of water is added through the funnel, with shaking to elicit hydrolysis of acetic anhydride. The flask is heated again in the glycerin bath for 10 minutes, for the purpose of completing hydrolysis. After cool-down, the funnel and flask walls are washed with 5 mL of ethyl alcohol.

A few drops of the phenolphthalein solution are added next as an indicator, and titration is performed using the above potassium hydroxide solution. The end point of the titration occurs when the pale red color of the indicator persists for about 30 seconds.

(B) Blank test

Titration is performed in the same manner as described above, except that herein no sample of crystalline resin or amorphous resin is used.

(3) The hydroxyl value is then calculated by plugging the obtained results into the expression below.

A=[{(B−C)×28.05×f}/S]+D

In the expression, A: hydroxyl value (mgKOH/g), B: addition amount (mL) of the potassium hydroxide solution in the blank test, C: addition amount (mL) of the potassium hydroxide solution in the main test, f: factor of the potassium hydroxide solution, S: mass (g) of the sample, and D: acid value (mgKOH/g) of the sample.

Cross-Sectional Observation of a Toner Particle

Firstly, a thin piece is produced as a reference sample of abundance.

The crystalline resin is thoroughly dispersed in a visible-light curable resin (product name: Aronix LCR series D-800), followed by curing through irradiation with-short-wavelength light. The obtained cured product is cut out with an ultramicrotome equipped with a diamond knife, to produce a 250 nm flaky sample. A flaky sample of the amorphous resin is prepared in the same manner.

The crystalline resin and the amorphous resin are mixed at 0/100, 30/70, 70/30 and 0/100, on a mass basis, and the mixtures are melt-kneaded, to yield kneaded products. These products are similarly dispersed in a visible light-curable resin, are cured, and are then cut out to thereby prepare flaky samples.

Cross sections of these cut reference samples are observed using a transmission electron microscope (electron microscope JEM-2800, by JEOL Ltd.) (TEM-EDX), and element mapping is performed by EDX. The elements to be mapped herein are carbon, oxygen and nitrogen.
Mapping conditions are as follows.
Acceleration voltage: 200 kV
Electron beam irradiation size: 1.5 nm
Live time limit: 600 sec
Dead time: 20-30
Mapping resolution: 256×256

Ratios of (oxygen intensity/carbon intensity) and (nitrogen intensity/carbon intensity) are calculated on the basis of the spectral intensity (average in a 10 nm square area) of each element, to prepare respective calibration curves relative to the mass ratios of the crystalline resin and amorphous resin. In the case where the monomer units of the crystalline resin contain nitrogen atoms, the calibration curve of (nitrogen intensity/carbon intensity) is resorted to in a further quantification.

Each toner sample is then analyzed.

After the toner has been sufficiently dispersed in a visible-light curable resin (Aronix LCR, series D-800), the resin is cured through irradiation with short-wavelength light. The resulting cured product is cut with an ultramicrotome equipped with a diamond knife, to produce a 250 nm flaky sample.

The cut sample is then observed using a transmission electron microscope (electron microscope JEM-2800 by JEOL Ltd.) (TEM-EDX). A toner particle cross-sectional image is obtained, and elemental mapping is performed by EDX. The elements to be mapped herein are carbon, oxygen and nitrogen.

Toner particle cross sections to be observed are selected as follows. Firstly, the cross-sectional area of a toner particle is worked out from an image of the cross section thereof, and the diameter of a circle (circle-equivalent diameter) having a surface area equal to the cross-sectional area is worked out. Herein there are only observed images of cross sections of a toner particle having an absolute value no greater than 1.0 μm of the difference between the circle-equivalent diameter and the weight-average particle diameter (D4) of the toner.

The toner particle cross section in the observation image is divided into 10 nm square areas. Herein (oxygen intensity/carbon intensity) and/or (nitrogen intensity/carbon intensity) is calculated on the basis of the (10 nm square average) spectral intensity of each element, in each area; the crystalline resin and the amorphous resin are then distinguished from each other as a result of a comparison against the above respective calibration curves. In a case where the content of the crystalline resin or amorphous resin is 80 mass % or higher the 10 nm square area is deemed to be taken up by the crystalline resin or amorphous resin. When a group of areas taken up by the amorphous resin is present in isolation, surrounded by a group of areas of the crystalline resin, the areas taken up by the amorphous resin are identified as amorphous domains. When an area group of the crystalline resin is present as a continuous phase, that area group is identified as a matrix. Since the toner particle has such a matrix and domains, the toner particle is therefore identified as having a domain-matrix structure made up of a matrix that contains the crystalline resin and domains that contain an amorphous resin.

A binarization process is performed thereafter, to measure the particle diameter of domains present in the toner particle cross-sectional image. The particle diameter is herein the major axis of the domains. The domain particle diameter is measured at 10 points per toner particle cross-section, for ten toner particle cross-sections in a toner particle cross-sectional image, whereupon the arithmetic mean value of the total 100 domain particle diameters is taken as number-average diameter (μm) of the domains.

In terms of domain surface area, S1 is defined herein as a total surface area worked out by summating the surface areas of all the domains present in one toner cross-sectional image. This is measured at 10 points per toner sample, whereupon the total surface area of the domains of the 10 toner particles (i.e. S1+S2 . . . +S100) is calculated, and the arithmetic mean value thereof is taken as the “domain surface area”.

Regarding the surface area of a toner particle cross section, the term “surface area of a cross section of a toner particle” is defined as the arithmetic mean value of values worked out by summating the cross-sectional areas (10 points per toner sample; 10 toner particles) of toner, worked out on the basis of the toner particle cross-sectional image used when deriving the domain surface area. Then the value [domain surface area]/[surface area of the cross section of the toner]×100 is taken as a ratio of the domain surface area (domain area ratio (%)) relative to the surface area of the cross section of the toner particle.

Binarization and area ratio calculation are carried out using Image Pro PLUS (by Nippon Roper KK).

Methods for Identifying the Monomer Units Making up the Crystalline Resin and the Amorphous Resin, and for Measuring the Content Ratio of Monomer Units

Identification of the monomer units that make up the crystalline resin and the amorphous resin and measurement of the content ratio of the monomer units are performed by ¹H-NMR under the conditions below.
Measuring device: FT NMR device JNM-EX400 (by JEOL Ltd.)
Measurement frequency: 400 MHz
Pulse condition: 5.0 μs
Frequency range: 10500 Hz
Number of scans: 64 scans
Measurement temperature: 30° C.

Sample: a sample is prepared by placing 50 mg of a measurement sample in a sample tube having an inner diameter of 5 mm, with addition of deuterated chloroform (CDCl₃) as a solvent, followed by dissolution in a thermostatic bath at 40° C.

From among the peaks attributed to the constituent elements of monomer units A, those peaks independent from peaks attributed to constituent elements of other monomer units are selected on the basis of the obtained ¹H-NMR chart, and an integration value S₁ of the selected peaks is calculated. From among the peaks attributed to the constituent elements of monomer units B, similarly, those peaks independent from peaks attributed to constituent elements of other monomer units are selected on the basis of the obtained ¹H-NMR chart, and an integration value S2 of the selected peaks is calculated. In a case where the resin further has monomer units X such as monomer units C, an integration value S_{X} is calculated in the same manner. The content ratio of the monomer units A is worked out as follows using the above integration value. Herein n₁, n₂ and nₓ are the numbers of hydrogen atoms in the constituent element to which a peak of interest is assigned for each respective segment.
Content ratio (mol %) of monomer units A=
{(S₁/n₁)/((S₁/n₁)+(S₂/n₂) . . . +(Sₓ/nₓ))}×100
Similarly, the content ratio of the monomer units B is worked out as follows.
Content ratio (mol %) of monomer units B=
{(S₂/n₂/)(S₁/n₁)+(S₂/n₂) . . . +(Sₓ/nₓ))}×100

Also in a case where monomer units X are present, the content ratio of the monomer units X is worked out in the same manner.

In a case where in the crystalline resin and the amorphous resin there is used a polymerizable monomer that contains no hydrogen in constituent elements other than a vinyl group, the above content ratio is calculated in the same way as in ¹H-NMR, but resorting herein to ¹³C-NMR using ¹³C as the measurement nucleus, in a single-pulse mode. Units of mol % can be converted to wt % on the basis of the molecular weight of the monomer units.

Method for Measuring the Weight-Average Molecular Weight (Mw) of Resins etc. by Gel Permeation Chromatography (GPC)

The weight-average molecular weight (Mw) of tetrahydrofuran (THF)-soluble matter such as resins is measured as follows by permeation chromatography (GPC).

Firstly, a sample is dissolved in tetrahydrofuran (THF) over 24 hours at room temperature. The obtained solution is then filtered through a solvent-resistant membrane filter “MYSYORI DISC” (by Tosoh Corporation) having a pore diameter of 0.2 μm, to yield a sample solution. The sample solution is adjusted so that the concentration of the component soluble in THF is about 0.8 mass %. This sample solution is then used for measurements under the following conditions.
Device: HLC8220 GPC (detector: RI) (by Tosoh Corporation)
Column: 7 columns Shodex KF-801, 802, 803, 804, 805, 806 and 807 (by Showa Denko KK)
Eluent: tetrahydrofuran (THF)
Flow rate: 1.0 mL/min
Oven temperature: 40.0° C.
Sample injection volume: 0.10 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

Method for Measuring the Melting Point, Endothermic Peak and Endothermic Quantity of Toner, Resins etc.

The melting points, endothermic peaks and endothermic quantities of the toner and the resins are measured using DSC Q1000 (by TA Instruments Inc.) under the following conditions.
Ramp rate: 10° C./min
Measurement start temperature: 20° C.
Measurement end temperature: 180° C.

The melting points of indium and zinc are used for temperature correction in the detection unit of the device, and the heat of fusion of indium is used for correcting the amount of heat. Specifically, about 5 mg of a sample are weighed exactly, are placed in an aluminum pan, and a differential scanning calorimetric measurement is performed. An empty pan made of silver is used as a reference. The peak temperature of a maximum endothermic peak in a first temperature rise process is taken as the melting point. In a case where there is a plurality of peaks, the maximum endothermic peak is the peak at which the endothermic quantity is maximal. The endothermic quantity of the maximum endothermic peak is worked out. Attribution of peaks can be determined on the basis of DSC measurements of materials separated from the toner described above.

Measurement of the BET Specific Surface Area of Inorganic Fine Particles

The BET specific surface area of the inorganic fine particles is measured according to JIS Z 8830 (2001). A concrete measuring method is as follows.

An “automatic specific surface area/pore distribution measurement apparatus TriStar 3000 (by Shimadzu Corp.)”, relying on a gas adsorption method based on a constant-volume method, is used as a measurement apparatus. Measurement conditions are set, and measurement data analyzed, using the dedicated software “TriStar 3000 Version 4.00” ancillary to the apparatus, and the apparatus is connected to a vacuum pump, a nitrogen gas tube, and a helium gas tube. A value calculated in accordance with the BET multi-point method using nitrogen gas as an adsorption gas is taken as the BET specific surface area of the inorganic fine particles in the present disclosure.

The BET specific surface area is calculated as follows.

Firstly, nitrogen gas is caused to adsorb onto the inorganic fine particles, whereupon there are measured an equilibrium pressure P (Pa) in a sample cell at that time and a nitrogen adsorption amount Va (mol·g⁻¹) of the inorganic fine particles. An adsorption isotherm is then obtained in which the horizontal axis represents relative pressure Pr, being a value obtained by dividing the equilibrium pressure P (Pa) in the sample cell by the saturated vapor pressure Po (Pa) of nitrogen, while the vertical axis represents the nitrogen adsorption amount Va (mol·g⁻¹).

A monomolecular layer adsorption amount Vm (mol·g⁻¹), which is the adsorption amount necessary to form a monomolecular layer on the surface of the inorganic fine particles, is worked out on the basis of the following BET expression.

Pr/Va(1−Pr)=1/(Vm×C)+(C−1)×Pr/(Vm×C)

(Herein C is the BET parameter, i.e. a variable which varies depending on the type of the measurement sample, the type of the adsorbed gas, and adsorption temperature)

The BET formula can be interpreted as a straight line (referred to as a BET plot) having a slope (C-1)/(Vm×C) and an intercept 1/(Vm×C), where Pr is the X-axis and Pr/Va (1-Pr) is the Y-axis.
Straight line slope=(C−1)/(Vm×C)
Straight line intercept=1/(Vm×C)

The slope and intercept of the straight line can be calculated by plotting the measured value of Pr and the measured value of Pr/Va (1-Pr) on a graph, and drawing a straight line in accordance with a least-squares method. Herein Vm and C can be calculated by solving the simultaneous equations of the slope and the intercept, using these values.

The BET specific surface area S (m²/g) of the inorganic fine particles is calculated, on the basis of the expression below, from the Vm calculated above and the molecular cross-sectional area (0.162 nm²) taken up by nitrogen molecules.

S=Vm×N×0.162×10⁻¹⁸

(where N is Avogadro's number (mol⁻¹))

The measurement using this device is performed in accordance with the “TriStar 3000 Instruction Manual V4.0” ancillary to the device, specifically according to the following procedure.

A thoroughly washed and dried dedicated glass sample cell (⅜ inch stem diameter, about 5 mL in volume) is weighed exactly. Then about 0.1 g of inorganic fine particles is placed into the sample cell using a funnel.

The sample cell containing the inorganic fine particles is set in a “pretreatment device VacuPrep 061 (by Shimadzu Corporation)” having a vacuum pump and a nitrogen gas tube connected thereto, and vacuum degassing is conducted continuously at 23° C. for about 10 hours. Vacuum degassing is performed concurrently with gradual valve adjustment, so that the inorganic fine particles are not sucked into the vacuum pump. The pressure inside the cell drops gradually as degassing progresses, reaching finally about 0.4 Pa (about 3 mTorr).

Once vacuum degassing is over, nitrogen gas is gradually injected to revert the interior of the sample cell to atmospheric pressure, and the sample cell is removed from the pretreatment device. The mass of the sample cell is weighed exactly, and the accurate mass of the inorganic fine particles is calculated on the basis of a difference relative to the tare. At this time the sample cell is lidded with a rubber plug during weighing, so that the inorganic fine particles in the sample cell do not become contaminated, for instance with moisture in the atmosphere.

A special “isothermal jacket” is subsequently fitted to the stem of the sample cell that holds the inorganic fine particles. A dedicated filler rod is then inserted into this sample cell, and the sample cell is set in the analysis port of the device. The isothermal jacket is a tubular member the inner surface of which is made up of a porous material, with the outer surface made up of an impermeable material, the jacket being capable of sucking liquid nitrogen up by capillarity, up to a given level.

A measurement of the free space of the sample cell, including a connecting device, is then carried out. The volume of the sample cell is measured with helium gas at 23° C., and then the volume of the sample cell, after cooling thereof with liquid nitrogen, is measured similarly using helium gas; the free space is then calculated through conversion from the difference in the measured volumes. The saturated vapor pressure Po (Pa) of nitrogen is automatically measured separately using a Po tube that is built into the device.

The interior of the sample cell is then vacuum-degassed, after which the sample cell is cooled down with liquid nitrogen while under continuous vacuum degassing. Nitrogen gas is introduced thereafter stepwise into the sample cell, to elicit adsorption of nitrogen molecules onto the inorganic fine particles. At this time the adsorption isotherm is converted to a BET plot, since adsorption isotherms can be obtained by measuring the equilibrium pressure P (Pa) at any time.

There are set a total of six points of the relative pressure Pr for data collection, namely 0.05, 0.10, 0.15, 0.20 0.25 and 0.30.

A straight line is drawn for the obtained measurement data, by least squares, and Vm is calculated on the basis of the slope and intercept of the straight line. The BET specific surface area of the inorganic fine particles is then calculated, as described above, using this Vm value.

Method for Measuring the Number-Average Diameter of Primary Particles of Inorganic Fine Particles and Pigments

The number-average diameter of the primary particles of inorganic fine particles and pigments is measured herein using a scanning electron microscope “S-4800” (product name; by Hitachi Ltd.), in combination with elemental analysis by energy dispersive X-ray spectroscopy (EDS). Toner having had inorganic fine particles and a pigment internally added thereto is observed, and the inorganic fine particles and the pigment are captured in a field of view magnified up to a maximum of 200000 magnifications. The inorganic fine particles and the pigment are selected from the captured image, and the major axes of 100 primary particles of inorganic fine particles and pigment are randomly measured, to determine the number-average diameter of the inorganic fine particles and the pigment. The observation magnifications are adjusted as appropriate according to the sizes of the inorganic fine particles and the pigment.

Method for Measuring Weight-average Particle Diameter (D4) of Toner (Toner Particle)

The weight-average particle diameter (D4) of the toner (toner particle) is calculated by carrying out measurements using a precision particle size distribution measuring device which employees a pore electrical resistance method and uses a 100 μm aperture tube (“Coulter Counter Multisizer 3” (registered trademark) available from Beckman Coulter) and accompanying dedicated software that is used to set measurement conditions and analyze measured data (“Beckman Coulter Multisizer 3 Version 3.51 produced by Beckman Coulter) (no. of effective measurement channels: 25,000), and then analyzing the measurement data.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements. Moreover, the dedicated software was set up as follows before carrying out measurements and analysis.

On the “Standard Operating Method (SOM) alteration screen” in the dedicated software, the total count number in control mode is set to 50,000 particles, the number of measurements is set to 1, and the Kd value is set to “standard particle 10.0 μm” (Beckman Coulter). By pressing the threshold value/noise level measurement button, threshold values and noise levels are automatically set. In addition, the current is set to 1600 μA, the gain is set to 2, the electrolyte solution is set to ISOTON II, and the “Flush aperture tube after measurement” option is checked. On the “Screen for converting from pulse to particle diameter” in the dedicated software, the bin interval is set to logarithmic particle diameter, the particle diameter bin is set to 256 particle diameter bin, and the particle diameter range is set to from 2 μm to 60 The specific measurement method is as follows.
(1) 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
(2) 30 mL of the aqueous electrolyte solution is placed in a 100 mL glass flat bottomed beaker, and approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) 3-fold with ion exchanged water, is added to the beaker as a dispersing agent.
(3) A prescribed amount of ion exchanged water is placed in a water tank of an “Ultrasonic Dispersion System Tetora 150” (available from Nikkaki Bios Co., Ltd.) having an electrical output of 120 W, in which 2 oscillators having an oscillation frequency of 50 kHz are housed so that their phases are staggered by 180°, and approximately 2 mL of the Contaminon N is added to the water tank.
(4) The beaker used in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
(5) While the aqueous electrolyte solution in the beaker mentioned in section (4) above is being irradiated with ultrasonic waves, approximately 10 mg of toner particles are added a little at a time to the aqueous electrolyte solution and dispersed therein. The ultrasonic wave dispersion treatment is continued for a further 60 seconds. Moreover, when carrying out the ultrasonic wave dispersion, the temperature of the water tank is adjusted as appropriate to a temperature of from 10° C. to 40° C.
(6) The aqueous electrolyte solution mentioned in section (5) above, in which the toner (toner particle) is dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.
(7) The weight average particle diameter (D4) is calculated by analyzing measurement data using the accompanying dedicated software. Moreover, when setting the graph/vol. % with the dedicated software, the “average diameter” on the analysis/volume-based statistical values (arithmetic mean) screen is weight average particle diameter (D4).

### EXAMPLES

The present disclosure will now be explained in greater detail using the working examples given below. However, these working examples in no way limit the present disclosure. In the formulations below, “parts” always means parts by mass unless explicitly indicated otherwise.

### Production Example of Crystalline Resin 1

| | |
|---|---|
| Solvent: toluene | 100.0 parts |
| Monomer composition | 100.0 parts |

(The monomer composition is a mixture of the following behenyl acrylate, acrylonitrile, acrylic acid and styrene, in the proportions given below)

| | |
|---|---|
| Behenyl acrylate | 50.0 parts |
| Styrene | 30.0 parts |
| Acrylonitrile | 15.0 parts |
| 2-hydroxyethyl acrylate | 5.0 parts |
| Polymerization initiator | 0.5 parts |

[t-butyl peroxypivalate (by NOF Corporation: Perbutyl PV)]

The above materials were charged, under a nitrogen atmosphere, into a reaction vessel equipped with a reflux condenser, a stirrer, a thermometer and a nitrogen introduction tube. A polymerization reaction was conducted for 12 hours, through heating at 70° C. while the interior of the reaction vessel was stirred at 200 rpm, to yield a solution in which a polymer of the monomer composition was dissolved in toluene. Subsequently, the temperature of the solution was lowered to 25° C. and then the solution was added to 1000.0 parts of methanol, while under stirring, to elicit precipitation of a methanol-insoluble fraction. The obtained methanol-insoluble fraction was separated by filtration, was further washed with methanol, and was thereafter vacuum-dried at 40° C. for 24 hours, to yield a first resin 1 (Crystalline resin 1). Physical properties are given in Table 2.

### Production Examples of Crystalline Resins 2 to 12 and 14 to 16

Crystalline resins 2 to 12 and crystalline resins 14 to 16 were obtained in the same way as in the production example of Crystalline resin 1, but herein the monomers and parts by mass were modified as given in Table 1. Physical properties are given in Table 2.

TABLE 1

| | First | | Second | | Third | | Fourth | | Fifth | |
|---|---|---|---|---|---|---|---|---|---|---|
| | polymerizable | | polymerizable | | polymerizable | | polymerizable | | polymerizable | |
| | monomer | | monomer | | monomer | | monomer | | monomer | |
| Crystalline resin | Type | Parts | Type | Parts | Type | Parts | Type | Parts | Type | Parts |
| Crystalline resin 1 | BEA | 50.0 | Si | 30.0 | ACN | 15.0 | HEA | 5.0 | — | — |
| Crystalline resin 2 | BEA | 50.0 | St | 30.0 | ACN | 15.0 | HPA | 5.0 | — | — |
| Crystalline resin 3 | BEA | 50.0 | St | 30.0 | ACN | 13.0 | HEMA | 7.0 | — | — |
| Crystalline resin 4 | BEA | 50.0 | St | 30.0 | ACN | 17.0 | HPMA | 3.0 | — | — |
| Crystalline resin 5 | BEA | 50.0 | St | 30.0 | ACN | 10.0 | HEAA | 10.0 | — | — |
| Crystalline resin 6 | BEA | 50.0 | St | 20.0 | MCN | 25.0 | HEA | 5.0 | — | — |
| Crystalline resin 7 | STA | 50.0 | St | 30.0 | ACN | 15.0 | HEA | 5.0 | — | — |
| Crystalline resin 8 | MYA | 50.0 | St | 30.0 | ACN | 15.0 | HEA | 5.0 | — | — |
| Crystalline resin 9 | BEA | 35.0 | St | 30.0 | ACN | 30.0 | HEA | 5.0 | — | — |
| Crystalline resin 10 | BEA | 70.0 | St | 10.0 | ACN | 15.0 | HEA | 5.0 | — | — |
| Crystalline resin 11 | BEA | 50.0 | St | 30.0 | ACN | 15.0 | AA | 5.0 | — | — |
| Crystalline resin 12 | BEA | 50.0 | St | 28.0 | ACN | 15.0 | HEA | 5.0 | HDDA | 2.0 |
| Crystalline resin 14 | BEA | 50.0 | St | 35.0 | ACN | 15.0 | — | — | — | — |
| Crystalline resin 15 | BEA | 50.0 | St | 35.0 | — | — | HEA | 15.0 | — | — |
| Crystalline resin 16 | HDA | 50.0 | St | 35.0 | ACN | 15.0 | | | | |

The abbreviations in Table 1 are as follows.
BEA: behenyl acrylate
STA: stearyl acrylate
MYA: myricyl acrylate
HDA: hexadecyl acrylate
St: styrene
ACN: acrylonitrile
MCN: methacrytonitrile
HEA: 2-hydroxyethyl acrylate
HPA: 2-hydroxypropyl acrylate
HEMA: 2-hydroxyethyl methacrylate
HPMA: 2-hydroxypropyl methacrylate
HEAA: acrylic acid 2-hydroxyethylamide
AA: acrylic acid
HDDA: 1,6-hexanediol diacrylate

### Production Example of Crystalline Resin 13

1,10-decanediol 33.9 parts

(100.0 mol % relative to the total number of moles of polyhydric alcohol)
Dodecanedioic acid 66.1 parts

(100.0 mol % relative to the total number of moles of polyvalent carboxylic acid)
Tin 2-ethylhexanoate 0.5 parts

The above materials were weighed in a reaction vessel equipped with a condenser, a stirrer, a nitrogen introduction tube, and a thermocouple. The interior of the vessel was replaced with nitrogen gas, after which the temperature was gradually raised, and the reaction was conducted for 3 hours while under stirring at a temperature of 140° C. The pressure in the reaction vessel was lowered to 8.3 kPa, and the reaction was conducted for 4 hours while the temperature was maintained at 200° C. Thereafter, the pressure inside the reaction vessel was lowered to 5 kPa or below, and the reaction was conducted at 200° C. for 3 hours, to yield Crystalline resin 13. Physical properties are given in Table 2.

TABLE 2

| | | | | | THF- |
|---|---|---|---|---|---|
| | | | | | insoluble |
| Crystalline | AV | OHV | Tp | | fraction |
| resin | (mgKOH/g) | (mgKOH/g) | (° C.) | Mw | (mass %) |
| 1 | 0 | 30 | 60 | 24000 | 0 |
| 2 | 0 | 24 | 60 | 21000 | 0 |
| 3 | 0 | 45 | 61 | 45000 | 0 |
| 4 | 0 | 18 | 60 | 38000 | 0 |
| 5 | 0 | 60 | 58 | 48000 | 0 |
| 6 | 0 | 60 | 58 | 35000 | 0 |
| 7 | 0 | 40 | 50 | 26000 | 0 |
| 8 | 0 | 20 | 70 | 50000 | 0 |
| 9 | 0 | 45 | 60 | 24000 | 0 |
| 10 | 0 | 20 | 60 | 24000 | 0 |
| 11 | 30 | 30 | 60 | 20000 | 0 |
| 12 | 0 | 0 | 56 | 74000 | 15 |
| 13 | 20 | 20 | 72 | 60000 | 0 |
| 14 | 0 | 0 | 60 | 30000 | 0 |
| 15 | 0 | 70 | 58 | 32000 | 0 |
| 16 | 0 | 0 | 47 | 26000 | 0 |

In the table, AV denotes the acid value, OHV denotes the hydroxyl value, Tp denotes the peak temperature of an endothermic peak corresponding to the crystalline resin, Mw denotes the weight-average molecular weight, and THF-insoluble fraction denotes the content ratio for the tetrahydrofuran-insoluble fraction of the crystalline resin.

### Production Example of Amorphous Resin 1

The materials below were charged, under a nitrogen atmosphere, into a reaction vessel equipped with a reflux condenser, a stirrer, a thermometer and a nitrogen introduction tube.
Polyoxyethylene (2.0)-2,2-bis(4-hydroxyphenyl) propane: 71.4 parts by mass (100.0 mol % relative to the total number of moles of polyhydric alcohol)
Terephthalic acid: 14.7 parts by mass (50.0 mol % relative to the total number of moles of polyvalent carboxylic acid)
Adipic acid: 5.2 parts by mass (20.0 mol % with respect to the total number of moles of polyvalent carboxylic acid)
Fumaric acid: 4.1 parts by mass (20.0 mol % with respect to the total number of moles of polyvalent carboxylic acid)
Dodecenyl succinic anhydride: 4.7 parts by mass (10.0 mol % relative to the total number of moles of polyvalent carboxylic acid)
Titanium tetrabutoxide: 2.0 parts by mass

Next, the interior of the vessel was replaced with nitrogen gas, the temperature was gradually raised, while under stirring, to 200° C., and the reaction was conducted for 2 hours while the produced water was distilled off. The pressure in the reaction vessel was lowered to 8.3 kPa, and was maintained for 1 hour, followed by cooling down to 180° C., and reversal to atmospheric pressure (first reaction step).
Trimellitic anhydride: 8.2 parts by mass (0.02 mol; 5.0 mol % relative to the total number of moles of polyvalent carboxylic acid)
tert-butyl catechol (polymerization inhibitor): 0.1 parts by mass

Thereafter, the above materials were added, the pressure in the reaction vessel was lowered to 8.3 kPa, the reaction was conducted for 4 hours while the temperature was maintained at 150° C., and then the reaction was stopped through lowering of the temperature (second reaction step), to yield a Second resin 1. Physical properties are given in Table 4.

### Production Examples of Amorphous Resins 2 to 6

Amorphous resins 2 to 6 were obtained in the same way as in the production example of Amorphous resin 1, but herein respective monomers and parts by mass were modified as given in Table 3. Physical properties are given in Table 4.

TABLE 3

| Amorphous | | | | | | | | | | |
|---|---|---|---|---|---|---|---|---|---|---|
| resin | Type | mol % | Type | mol % | Type | mol % | Type | mol % | Type | mol % |
| 1 | BPO-EO | 50.0 | TPA | 25.0 | FA | 10.0 | AA | 10.0 | DSA | 5.0 |
| 2 | BPO-EO | 50.0 | TPA | 25.0 | FA | 10.0 | AA | 15.0 | — | |
| 3 | BPO-EO | 50.0 | TPA | 25.0 | FA | 7.0 | AA | 18.0 | — | |
| 4 | BPO-EO | 50.0 | TPA | 32.0 | FA | 1.0 | AA | 17.0 | — | |
| 5 | BPO-EO | 50.0 | TPA | 25.0 | FA | 18.0 | AA | 7.0 | — | |
| 6 | BPO-EO | 50.0 | TPA | 25.0 | FA | 20.0 | AA | 5.0 | — | |

The abbreviations for Table 3 are as follows.
BPO-EO: Polyoxyethylene (2.0)-2,2-bis(4-hydroxyphenyl)propane
TPA: terephthalic acid
FA: fumaric acid
AA: adipic acid
DSA: dodecenyl succinic anhydride

### Production Example of Amorphous Resin 7

An autoclave was charged with 50.0 parts by mass of xylene, was purged with nitrogen, and was then heated to 185° C. in a sealed state, while under stirring. To the autoclave there were continuously added dropwise, over 3 hours, 70.0 parts by mass of styrene, 20.0 parts by mass of n-butyl acrylate, 3.0 parts by mass of methyl methacrylate, 5.0 parts by mass of acrylic acid, 2.0 parts by mass of divinylbenzene, and a mixed solution of 1.0 part of di-tert-butyl peroxide and 20.0 parts of xylene, and polymerization was conducted while the internal temperature of the autoclave was controlled to 190° C. The autoclave was kept at the same temperature for 1 hour, to complete the polymerization, and the solvent was removed, to yield an amorphous resin 7. Physical properties are given in Table 4.

### Production Example of Amorphous Resin 8

An autoclave was charged with 50.0 parts by mass of xylene, was purged with nitrogen, and was thereafter heated to 185° C. in a sealed state, while under stirring. To the autoclave there were continuously added dropwise, over 3 hours, 30.0 parts by mass of styrene, 40.0 parts by mass of n-butyl acrylate, 23.0 parts by mass of stearyl acrylate, 5.0 parts by mass of acrylic acid, 2.0 parts by mass of divinylbenzene, and a mixed solution of 1.0 part of di-tert-butyl peroxide and 20.0 parts of xylene, and polymerization was conducted while the internal temperature of the autoclave was controlled to 190° C. The autoclave was kept at the same temperature for 1 hour, to complete the polymerization, and the solvent was removed, to yield an Amorphous resin 8. Physical properties are given in Table 4.

TABLE 4

| Amorphous | AV | OHV | |
|---|---|---|---|
| resin | (mgKOH/g) | (mgKOH/g) | Mw |
| 1 | 30 | 10 | 20000 |
| 2 | 24 | 5 | 21000 |
| 3 | 45 | 12 | 15000 |
| 4 | 18 | 15 | 24000 |
| 5 | 60 | 8 | 21000 |
| 6 | 60 | 3 | 21000 |
| 7 | 40 | 0 | 12000 |
| 8 | 35 | 0 | 20000 |

In the table, AV denotes acid value, OHV denotes hydroxyl value, and Mw denotes weight-average molecular weight.

### Production Example of Binder Resin 1

Herein 40 parts of Amorphous resin 1 and 60 parts of Crystalline resin 1 were mixed, and homogenized at 170° C., in a reaction vessel equipped with a condenser, a stirrer and a nitrogen introduction tube. Thereafter, 2 parts of di-t-butyl peroxide were added, and the reaction was conducted at 170° C. for 1 hour. The pressure was then lowered under conditions of 1.0 kPa at 170° C., for 2 hours, to remove decomposition products derived from the initiator. Binder resin 1 was then obtained by cooling the resulting product.

### Production Examples of Binder Resins 2 to 22

Binder resins 2 to 22 were obtained in the same way as in the production example of Binder resin 1, but herein the types and parts by mass of the amorphous resin and the crystalline resin were modified as given in Table 5.

TABLE 5

| Binder | | Parts | | Parts |
|---|---|---|---|---|
| resin | Crystalline resin | by mass | Amorphous resin | by mass |
| 1 | Crystalline resin 1 | 60 | Amorphous resin 1 | 40 |
| 2 | Crystalline resin 1 | 60 | Amorphous resin 2 | 40 |
| 3 | Crystalline resin 1 | 60 | Amorphous resin 3 | 40 |
| 4 | Crystalline resin 1 | 69 | Amorphous resin 2 | 31 |
| 5 | Crystalline resin 1 | 60 | Amorphous resin 4 | 40 |
| 6 | Crystalline resin 1 | 60 | Amorphous resin 5 | 40 |
| 7 | Crystalline resin 1 | 60 | Amorphous resin 6 | 40 |
| 8 | Crystalline resin 2 | 60 | Amorphous resin 2 | 40 |
| 9 | Crystalline resin 3 | 60 | Amorphous resin 2 | 40 |
| 10 | Crystalline resin 4 | 60 | Amorphous resin 2 | 40 |
| 11 | Crystalline resin 5 | 60 | Amorphous resin 2 | 40 |
| 12 | Crystalline resin 6 | 60 | Amorphous resin 2 | 40 |
| 13 | Crystalline resin 1 | 50 | Amorphous resin 2 | 50 |
| 14 | Crystalline resin 7 | 60 | Amorphous resin 2 | 40 |
| 15 | Crystalline resin 7 | 50 | Amorphous resin 2 | 50 |
| 16 | Crystalline resin 8 | 60 | Amorphous resin 2 | 40 |
| 17 | Crystalline resin 9 | 60 | Amorphous resin 2 | 40 |
| 18 | Crystalline resin 10 | 60 | Amorphous resin 2 | 40 |
| 19 | Crystalline resin 11 | 60 | Amorphous resin 2 | 40 |
| 20 | Crystalline resin 11 | 60 | Amorphous resin 7 | 40 |
| 21 | Crystalline resin 13 | 60 | Amorphous resin 2 | 40 |
| 22 | Crystalline resin 13 | 60 | Amorphous resin 7 | 40 |

### Production Example of Inorganic Fine Particles 1

The combustion furnace used herein was a hydrocarbon-oxygen mixed burner with a double-tube structure, capable of forming an inner flame and an outer flame. A two-fluid nozzle for slurry injection was grounded at the center of the burner, and a starting silicon compound was introduced. A hydrocarbon-oxygen combustible gas was injected from the periphery of the two-fluid nozzle, to form the outer flame and the inner flame of a reducing atmosphere.

The atmosphere, temperature, flame length and so forth were adjusted by controlling the amount and flow rate of the combustible gas and oxygen. Silica fine particles were formed from the silicon compound in the flame, and were further fused until a desired particle diameter was obtained. This was followed by cooling, after which the resulting product was collected for instance in a bag filter, to yield silica fine particles. The silica fine particles were produced using hexamethylcyclotrisiloxane as the starting silicon compound. Next, 100 parts of the obtained silica fine particles were surface-treated with 4 parts of hexamethyldisilazane, to yield silica fine particles as Inorganic fine particles 1 having a number-average diameter of primary particles of 100 nm.

### Production Example of Inorganic Fine Particles 4 and 5

In the production example of Inorganic fine particles 1, the number-average diameter of the primary particles was adjusted by controlling the amounts and flow rates of the combustible gas and oxygen, to yield Inorganic fine particles 4 and 5.

### Production Example of Inorganic Fine Particles 2

Herein 200 mL of a 50% ethanol/water solution were cooled to a temperature in the range from −20° C. to 10° C., whereupon 160 g of Ca(OH)₂ were added, to form a slurry. A mixed gas having a carbon dioxide gas/nitrogen gas 30% composition was introduced from the bottom of a vessel at a flow rate of 500 mL/min to 5000 mL/min, while under strong stirring, and the reaction was conducted until the pH of the slurry began to drop. At this time, the reaction temperature and the introduction rate of carbon dioxide gas were adjusted so that the number-average diameter of the primary particles was 200 nm, and yield a slurry of synthetic calcium carbonate. The resulting dispersion was filtered while still in a low-temperature state, was thoroughly washed with pure water, and was thereafter dried, to yield synthetic calcium carbonate.

Water adjusted to 70° C. was added to the obtained synthetic calcium carbonate so that the solids were 10 mass %, and a slurry was prepared using a stirring type disperser. Then 1.0 g of saponified stearic acid was added to 1 kg of this synthetic calcium carbonate slurry while under stirring using a disperser; the whole was then stirred for 20 minutes, followed by press dehydration. Herein slurries of hydrophobized calcium carbonate having different fatty acid treatment amounts and fatty acid treatment distributions were obtained by modifying the amount of fatty acid added and the time of stirring. After drying of the obtained dehydrated cake, the resulting dry cake was deagglomerated and made into a powder, to yield about 100 g of Inorganic fine particles 2 in the form of calcium carbonate having been subjected to a hydrophobizing surface treatment with a fatty acid.

### Production Example of Inorganic Fine Particles 3

Inorganic fine particles 3 were obtained by being produced in accordance with a method similar to that of the production example of Inorganic fine particles 2, but modifying herein the reaction temperature and the introduction rate of carbon dioxide gas.

### Production Example of Toner Particle 1

Binder resin 1 80 parts by mass
Hydrocarbon wax (produced in accordance with the Fischer-Tropsch method, and having a melting point of 90° C.) 5 parts by mass
Colorant (Cyan pigment by Dainichiseika Color & Chemicals Mfg. Co., Ltd.: Pigment Blue 15:3) 5 parts by mass
Inorganic fine particles 1 (silica fine particles in Table 5) 10 parts by mass

The above materials were mixed using a Henschel mixer (Model FM-75, by Nippon Coke & Engineering Co., Ltd.) at a rotational speed of 20 s-1 and for a rotation time of 3 minutes. The resulting mixture was kneaded at a screw rotational speed of 250 rpm and at a discharge temperature of 110° C., using a twin-screw kneader (PCM-30 model, by Ikegai Corp.) set at a temperature of 120° C. The obtained kneaded product was cooled and coarsely pulverized to a size of 1 mm or less, using a hammer mill, to yield a coarsely pulverized product. The resulting coarsely pulverized product was finely pulverized using a mechanical pulverizer (T-250, by Freund-Turbo Corporation).

The resulting product was classified using Faculty F-300 (by Hosokawa Micron Corporation), to yield Toner particle 1 having a weight-average particle diameter of about 6.0 The operating conditions were set to a rotational speed of 130 s-1 of a classification rotor, and a rotational speed of 120 s-1 of a distribution rotor.

### Production Examples of Toner Particles 2 to 44

Toner particles 2 to 44 were produced in the same way as in the production example of Toner particle 1, but modifying herein the types and number of parts of the binder resin, crystalline resin, amorphous resin, inorganic fine particles and colorant that were used, to those given in Table 6-1, Table 6-2, Table 7 and Table 8.

TABLE 6-1

| | | | Internal addition formulation | | | | |
|---|---|---|---|---|---|---|---|
| | | Parts | | Parts | | Parts | |
| Toner particle | Binder resin | by mass | Crystalline resin | by mass | Amorphous resin | by mass | C/H |
| Toner particle 1 | Binder resin 1 | 80 | Crystalline resin 1 | 48 | Amorphous resin 1 | 32 | 60 |
| Toner particle 2 | Binder resin 1 | 80 | Crystalline resin 1 | 48 | Amorphous resin 1 | 32 | 60 |
| Toner particle 3 | Binder resin 2 | 80 | Crystalline resin 1 | 48 | Amorphous resin 2 | 32 | 60 |
| Toner particle 4 | Binder resin 2 | 85 | Crystalline resin 1 | 51 | Amorphous resin 2 | 34 | 60 |
| Toner particle 5 | Binder resin 2 | 85 | Crystalline resin 1 | 51 | Amorphous resin 2 | 34 | 60 |
| Toner particle 6 | Binder resin 2 | 75 | Crystalline resin 1 | 45 | Amorphous resin 2 | 30 | 60 |
| Toner particle 7 | Binder resin 2 | 75 | Crystalline resin 1 | 45 | Amorphous resin 2 | 30 | 60 |
| Toner particle 8 | Binder resin 2 | 80 | Crystalline resin 1 | 48 | Amorphous resin 2 | 32 | 60 |
| Toner particle 9 | Binder resin 2 | 80 | Crystalline resin 1 | 48 | Amorphous resin 2 | 32 | 60 |
| Toner particle 10 | Binder resin 2 | 70 | Crystalline resin 1 | 42 | Amorphous resin 2 | 28 | 60 |
| Toner particle 11 | Binder resin 3 | 85 | Crystalline resin 1 | 51 | Amorphous resin 3 | 34 | 60 |
| Toner particle 12 | Binder resin 4 | 85 | Crystalline resin 1 | 59 | Amorphous resin 2 | 26 | 70 |
| Toner particle 13 | Binder resin 5 | 85 | Crystalline resin 1 | 51 | Amorphous resin 4 | 34 | 60 |
| Toner particle 14 | Binder resin 6 | 80 | Crystalline resin 1 | 48 | Amorphous resin 5 | 32 | 60 |
| Toner particle 15 | Binder resin 7 | 80 | Crystalline resin 1 | 48 | Amorphous resin 6 | 32 | 60 |
| Toner particle 16 | Binder resin 7 | 70 | Crystalline resin 1 | 42 | Amorphous resin 6 | 28 | 60 |
| Toner particle 17 | Binder resin 8 | 80 | Crystalline resin 2 | 48 | Amorphous resin 2 | 32 | 60 |
| Toner particle 18 | Binder resin 9 | 80 | Crystalline resin 3 | 48 | Amorphous resin 2 | 32 | 60 |
| Toner particle 19 | Binder resin 10 | 80 | Crystalline resin 4 | 48 | Amorphous resin 2 | 32 | 60 |
| Toner particle 20 | Binder resin 11 | 80 | Crystalline resin 5 | 48 | Amorphous resin 2 | 32 | 60 |
| Toner particle 21 | Binder resin 12 | 80 | Crystalline resin 6 | 48 | Amorphous resin 2 | 32 | 60 |
| Toner particle 22 | Binder resin 13 | 80 | Crystalline resin 1 | 40 | Amorphous resin 2 | 40 | 50 |
| Toner particle 23 | Binder resin 14 | 80 | Crystalline resin 7 | 48 | Amorphous resin 2 | 32 | 60 |
| Toner particle 24 | Binder resin 15 | 80 | Crystalline resin 7 | 40 | Amorphous resin 2 | 40 | 50 |
| Toner particle 25 | Binder resin 16 | 80 | Crystalline resin 8 | 48 | Amorphous resin 2 | 32 | 60 |
| Toner particle 26 | Binder resin 17 | 80 | Crystalline resin 9 | 48 | Amorphous resin 2 | 32 | 60 |
| Toner particle 27 | Binder resin 18 | 80 | Crystalline resin 10 | 48 | Amorphous resin 2 | 32 | 60 |
| Toner particle 28 | Binder resin 19 | 80 | Crystalline resin 11 | 48 | Amorphous resin 2 | 32 | 60 |
| Toner particle 29 | Binder resin 1 | 80 | Crystalline resin 1 | 48 | Amorphous resin 7 | 32 | 60 |
| Toner particle 30 | Binder resin 20 | 80 | Crystalline resin 11 | 48 | Amorphous resin 7 | 32 | 60 |
| Toner particle 31 | — | — | Crystalline resin 12 | 80 | — | — | 100 |
| Toner particle 32 | Binder resin 21 | 80 | Crystalline resin 13 | 48 | Amorphous resin 2 | 32 | 60 |
| Toner particle 33 | Binder resin 22 | 80 | Crystalline resin 13 | 48 | Amorphous resin 7 | 32 | 60 |
| Toner particle 34 | Binder resin 1 | 80 | Crystalline resin 1 | 48 | Amorphous resin 2 | 32 | 60 |
| Toner particle 35 | Binder resin 1 | 70 | Crystalline resin 1 | 42 | Amorphous resin 2 | 28 | 60 |
| Toner particle 36 | Binder resin 1 | 90 | Crystalline resin 1 | 54 | Amorphous resin 2 | 36 | 60 |
| Toner particle 37 | Binder resin 1 | 87 | Crystalline resin 1 | 52 | Amorphous resin 2 | 35 | 60 |
| Toner particle 38 | Binder resin 1 | 60 | Crystalline resin 1 | 36 | Amorphous resin 2 | 24 | 60 |
| Toner particle 39 | — | — | Crystalline resin 14 | 48 | Amorphous resin 2 | 32 | 60 |
| Toner particle 40 | — | — | Crystalline resin 14 | 48 | Amorphous resin 7 | 32 | 60 |
| Toner particle 41 | — | — | Crystalline resin 14 | 54 | Amorphous resin 7 | 36 | 60 |
| Toner particle 42 | — | — | Crystalline resin 15 | 54 | Amorphous resin 2 | 36 | 60 |
| Toner particle 43 | — | — | Crystalline resin 16 | 54 | Amorphous resin 2 | 36 | 60 |
| Toner particle 44 | — | — | Crystalline resin 1 | 48 | Amorphous resin 8 | 32 | 60 |

In the table, C/H denotes the content ratio of the crystalline resin in the binder resin.

TABLE 6-2

| | Internal addition formulation | | | | | | External addition formulation | |
|---|---|---|---|---|---|---|---|---|
| | | Parts | | Parts | | Parts | | Parts |
| Toner particle | Pigment | by mass | Inorganic fine particles | by mass | Wax | by mass | External additive | by mass |
| Toner particle 1 | Cyan pigment | 5 | Inorganic fine particles 1 | 10 | Hydrocarbon wax | 5 | Inorganic fine particles 4 | 3 |
| Toner particle 2 | Cyan pigment | 5 | Inorganic fine particles 2 | 10 | Hydrocarbon wax | 5 | Inorganic fine particles 4 | 3 |
| Toner particle 3 | Cyan pigment | 5 | Inorganic fine particles 2 | 10 | Hydrocarbon wax | 5 | Inorganic fine particles 4 | 3 |
| Toner particle 4 | Cyan pigment | 5 | Inorganic fine particles 2 | 5 | Hydrocarbon wax | 5 | Inorganic fine particles 4 | 3 |
| Toner particle 5 | Cyan pigment | 5 | Inorganic fine particles 2 | 5 | Hydrocarbon wax | 5 | Inorganic fine particles 4 | 1 |
| Toner particle 6 | Magenta pigment | 10 | Inorganic fine particles 2 | 10 | Hydrocarbon wax | 5 | Inorganic fine particles 4 | 3 |
| Toner particle 7 | Black pigment | 10 | Inorganic fine particles 2 | 10 | Hydrocarbon wax | 5 | Inorganic fine particles 4 | 3 |
| Toner particle 8 | Yellow pigment | 5 | Inorganic fine particles 2 | 10 | Hydrocarbon wax | 5 | Inorganic fine particles 4 | 3 |
| Toner particle 9 | Cyan pigment | 5 | Inorganic fine particles 3 | 10 | Hydrocarbon wax | 5 | Inorganic fine particles 4 | 3 |
| Toner particle 10 | Cyan pigment | 5 | Inorganic fine particles 2 | 20 | Hydrocarbon wax | 5 | Inorganic fine particles 4 | 3 |
| Toner particle 11 | Cyan pigment | 5 | Inorganic fine particles 2 | 5 | Hydrocarbon wax | 5 | Inorganic fine particles 4 | 1 |
| Toner particle 12 | Cyan pigment | 5 | Inorganic fine particles 2 | 5 | Hydrocarbon wax | 5 | Inorganic fine particles 4 | 1 |
| Toner particle 13 | Cyan pigment | 5 | Inorganic fine particles 2 | 5 | Hydrocarbon wax | 5 | Inorganic fine particles 4 | 1 |
| Toner particle 14 | Cyan pigment | 5 | Inorganic fine particles 2 | 10 | Hydrocarbon wax | 5 | Inorganic fine particles 4 | 3 |
| Toner particle 15 | Cyan pigment | 5 | Inorganic fine particles 2 | 10 | Hydrocarbon wax | 5 | Inorganic fine particles 4 | 3 |
| Toner particle 16 | Cyan pigment | 5 | Inorganic fine particles 2 | 20 | Hydrocarbon wax | 5 | Inorganic fine particles 4 | 3 |
| Toner particle 17 | Cyan pigment | 5 | Inorganic fine particles 2 | 10 | Hydrocarbon wax | 5 | Inorganic fine particles 4 | 3 |
| Toner particle 18 | Cyan pigment | 5 | Inorganic fine particles 2 | 10 | Hydrocarbon wax | 5 | Inorganic fine particles 4 | 3 |
| Toner particle 19 | Cyan pigment | 5 | Inorganic fine particles 2 | 10 | Hydrocarbon wax | 5 | Inorganic fine particles 4 | 3 |
| Toner particle 20 | Cyan pigment | 5 | Inorganic fine particles 2 | 10 | Hydrocarbon wax | 5 | Inorganic fine particles 4 | 3 |
| Toner particle 21 | Cyan pigment | 5 | Inorganic fine particles 2 | 10 | Hydrocarbon wax | 5 | Inorganic fine particles 4 | 3 |
| Toner particle 22 | Cyan pigment | 5 | Inorganic fine particles 2 | 10 | Hydrocarbon wax | 5 | Inorganic fine particles 4 | 3 |
| Toner particle 23 | Cyan pigment | 5 | Inorganic fine particles 2 | 10 | Hydrocarbon wax | 5 | Inorganic fine particles 4 | 3 |
| Toner particle 24 | Cyan pigment | 5 | Inorganic fine particles 2 | 10 | Hydrocarbon wax | 5 | Inorganic fine particles 4 | 3 |
| Toner particle 25 | Cyan pigment | 5 | Inorganic fine particles 2 | 10 | Hydrocarbon wax | 5 | Inorganic fine particles 4 | 3 |
| Toner particle 26 | Cyan pigment | 5 | Inorganic fine particles 2 | 10 | Hydrocarbon wax | 5 | Inorganic fine particles 4 | 3 |
| Toner particle 27 | Cyan pigment | 5 | Inorganic fine particles 2 | 10 | Hydrocarbon wax | 5 | Inorganic fine particles 4 | 3 |
| Toner particle 28 | Cyan pigment | 5 | Inorganic fine particles 2 | 10 | Hydrocarbon wax | 5 | Inorganic fine particles 4 | 3 |
| Toner particle 29 | Cyan pigment | 5 | Inorganic fine particles 2 | 10 | Hydrocarbon wax | 5 | Inorganic fine particles 4 | 3 |
| Toner particle 30 | Cyan pigment | 5 | Inorganic fine particles 2 | 10 | Hydrocarbon wax | 5 | Inorganic fine particles 4 | 3 |
| Toner particle 31 | Cyan pigment | 5 | Inorganic fine particles 2 | 10 | Hydrocarbon wax | 5 | Inorganic fine particles 4 | 3 |
| Toner particle 32 | Cyan pigment | 5 | Inorganic fine particles 2 | 10 | Hydrocarbon wax | 5 | Inorganic fine particles 4 | 3 |
| Toner particle 33 | Cyan pigment | 5 | Inorganic fine particles 2 | 10 | Hydrocarbon wax | 5 | Inorganic fine particles 4 | 3 |
| Toner particle 34 | Cyan pigment | 5 | Inorganic fine particles 4 | 10 | Hydrocarbon wax | 5 | Inorganic fine particles 4 | 3 |
| Toner particle 35 | Cyan pigment | 5 | Inorganic fine particles 4 | 20 | Hydrocarbon wax | 5 | Inorganic fine particles 4 | 3 |
| Toner particle 36 | Cyan pigment | 5 | None | | Hydrocarbon wax | 5 | Inorganic fine particles 4 | 1 |
| Toner particle 37 | Black pigment | 8 | None | | Hydrocarbon wax | 5 | Inorganic fine particles 4 | 1 |
| Toner particle 38 | Cyan pigment | 5 | Inorganic fine particles 5 | 30 | Hydrocarbon wax | 5 | Inorganic fine particles 4 | 3 |
| Toner particle 39 | Cyan pigment | 5 | Inorganic fine particles 5 | 10 | Hydrocarbon wax | 5 | Inorganic fine particles 4 | 3 |
| Toner particle 40 | Cyan pigment | 5 | Inorganic fine particles 5 | 10 | Hydrocarbon wax | 5 | Inorganic fine particles 4 | 3 |
| Toner particle 41 | Cyan pigment | 5 | None | | Hydrocarbon wax | 5 | Inorganic fine particles 4 | 3 |
| Toner particle 42 | Cyan pigment | 5 | None | | Hydrocarbon wax | 5 | Inorganic fine particles 4 | 3 |
| Toner particle 43 | Cyan pigment | 5 | None | | Hydrocarbon wax | 5 | Inorganic fine particles 4 | 3 |
| Toner particle 44 | Cyan pigment | 5 | Inorganic fine particles 2 | 10 | Hydrocarbon wax | 5 | Inorganic fine particles 4 | 3 |

TABLE 7

| | | | Number-average | BET specific |
|---|---|---|---|---|
| | | | diameter of primary | surface area |
| Inorganic fine particles | Composition | Surface treatment | particles (nm) | (m²/g) |
| Inorganic fine particles 1 | Silica | Hexamethyldisilazane | 100 | 30 |
| Inorganic fine particles 2 | Calcium carbonate | Stearic acid | 200 | 12 |
| Inorganic fine particles 3 | Calcium carbonate | Stearic acid | 450 | 5 |
| Inorganic fine particles 4 | Silica | Hexamethyldisilazane | 80 | 50 |
| Inorganic fine particles 5 | Silica | Hexamethyldisilazane | 45 | 80 |

TABLE 8

| | | Number-average |
|---|---|---|
| | | diameter of primary |
| Colorant | Composition | particles (nm) |
| Cyan pigment | Pigment Blue 15:3 | 90 |
| Magenta pigment | Pigment Red 122 | 150 |
| Yellow pigment | Pigment Yellow 180 | 200 |
| Black pigment | Carbon black | 40 |

### Production Example of Toner 1

| | |
|---|---|
| Toner particle 1 | 100 parts |
| Inorganic fine particles 1 | 3 parts |

The above materials were mixed in a Henschel Mixer Model FM-10C (by Mitsui Miike Engineering Corporation) at a rotational speed of 50 s-1 for a rotation time of 10 minutes, to yield Toner 1. Tables 9-1 and 9-2 set out the physical properties of Toner 1.

### Production Examples of Toners 2 to 44

Toners 2 to 44 were produced in the same way as in the production example of Toner 1, but herein with Toner particles 2 to 44 as the toner particle used as a material, and by modifying the type and parts by mass of the inorganic fine particles as given in the item “External addition formulation” in Table 6-2. Tables 9-1 and 9-2 set out the physical properties of Toners 2 to 44 that were obtained.

TABLE 9-1

| | Weight-average | Cross-sectional structure | | | | | | |
|---|---|---|---|---|---|---|---|---|
| | particle size | | | Domain | Domain | | | |
| | Weight-average | | | number-average | area | | | |
| | particle size D4 | | | diameter | ratio | Viscoelasticity | | |
| Toner | (μm) | Matrix | Domains | (μm) | (%) | G′(1) | G″(1) | G′(50) |
| 1 | 6.1 | Crystalline resin | Amorphous resin | 0.40 | 38 | 20000 | 18000 | 2000 |
| 2 | 6.1 | Crystalline resin | Amorphous resin | 0.40 | 40 | 22000 | 20000 | 2500 |
| 3 | 6.1 | Crystalline resin | Amorphous resin | 0.80 | 46 | 14000 | 12000 | 2600 |
| 4 | 6.1 | Crystalline resin | Amorphous resin | 0.80 | 46 | 13000 | 11000 | 1800 |
| 5 | 6.1 | Crystalline resin | Amorphous resin | 0.80 | 46 | 12000 | 11000 | 1500 |
| 6 | 6.1 | Crystalline resin | Amorphous resin | 0.80 | 44 | 18000 | 16000 | 3500 |
| 7 | 6.1 | Crystalline resin | Amorphous resin | 0.80 | 48 | 15000 | 13000 | 3400 |
| 8 | 6.1 | Crystalline resin | Amorphous resin | 0.80 | 48 | 14000 | 12000 | 2700 |
| 9 | 6.1 | Crystalline resin | Amorphous resin | 0.80 | 48 | 14000 | 13000 | 3200 |
| 10 | 6.1 | Crystalline resin | Amorphous resin | 0.80 | 48 | 24000 | 23000 | 4600 |
| 11 | 6.1 | Crystalline resin | Amorphous resin | 0.80 | 48 | 11000 | 10000 | 1100 |
| 12 | 6.1 | Crystalline resin | Amorphous resin | 0.60 | 32 | 12000 | 10000 | 1000 |
| 13 | 6.1 | Crystalline resin | Amorphous resin | 0.80 | 48 | 11000 | 9000 | 1100 |
| 14 | 6.1 | Crystalline resin | Amorphous resin | 1.00 | 50 | 25000 | 23000 | 4200 |
| 15 | 6.1 | Crystalline resin | Amorphous resin | 1.20 | 52 | 26000 | 24000 | 4500 |
| 16 | 6.1 | Crystalline resin | Amorphous resin | 1.50 | 56 | 28000 | 25000 | 4800 |
| 17 | 6.1 | Crystalline resin | Amorphous resin | 0.80 | 47 | 17000 | 15000 | 2500 |
| 18 | 6.1 | Crystalline resin | Amorphous resin | 0.80 | 47 | 17000 | 15000 | 2400 |
| 19 | 6.1 | Crystalline resin | Amorphous resin | 0.80 | 47 | 18000 | 17000 | 2100 |
| 20 | 6.1 | Crystalline resin | Amorphous resin | 0.80 | 48 | 16000 | 15000 | 1600 |
| 21 | 6.1 | Crystalline resin | Amorphous resin | 0.80 | 48 | 18000 | 16000 | 2500 |
| 22 | 6.1 | Crystalline resin | Amorphous resin | 0.70 | 58 | 22000 | 20000 | 2500 |
| 23 | 6.1 | Crystalline resin | Amorphous resin | 0.70 | 46 | 16000 | 15000 | 3600 |
| 24 | 6.1 | Crystalline resin | Amorphous resin | 0.60 | 61 | 22000 | 20000 | 4400 |
| 25 | 6.1 | Crystalline resin | Amorphous resin | 0.80 | 46 | 25000 | 23000 | 2200 |
| 26 | 6.1 | Crystalline resin | Amorphous resin | 0.80 | 46 | 21000 | 18000 | 3600 |
| 27 | 6.1 | Crystalline resin | Amorphous resin | 0.70 | 45 | 18000 | 16000 | 2800 |
| 28 | 6.1 | Crystalline resin | Amorphous resin | 0.40 | 44 | 12000 | 13000 | 2900 |
| 29 | 6.1 | Crystalline resin | Amorphous resin | 0.80 | 48 | 16000 | 15000 | 3500 |
| 30 | 6.1 | Crystalline resin | Amorphous resin | 0.50 | 44 | 12000 | 15000 | 3500 |
| 31 | 6.1 | Crystalline resin | — | — | — | 10000 | 9000 | 2700 |
| 32 | 6.1 | Crystalline resin | Amorphous resin | 0.80 | 48 | 16000 | 18000 | 2800 |
| 33 | 6.1 | Crystalline resin | Amorphous resin | 0.80 | 48 | 16000 | 18000 | 3500 |
| 34 | 6.1 | Crystalline resin | Amorphous resin | 0.80 | 48 | 8200 | 7600 | 2000 |
| 35 | 6.1 | Crystalline resin | Amorphous resin | 0.80 | 48 | 12000 | 11000 | 5500 |
| 36 | 6.1 | Crystalline resin | Amorphous resin | 0.80 | 18 | 3000 | 3500 | 2400 |
| 37 | 6.1 | Crystalline resin | Amorphous resin | 0.80 | 48 | 3200 | 3500 | 2600 |
| 38 | 6.1 | Crystalline resin | Amorphous resin | 0.60 | 46 | 40000 | 38000 | 36000 |
| 39 | 6.1 | Crystalline resin | Amorphous resin | 1.20 | 50 | 21000 | 23000 | 16000 |
| 40 | 6.1 | Crystalline resin | Amorphous resin | 1.50 | 52 | 18000 | 20000 | 15000 |
| 41 | 6.1 | Crystalline resin | Amorphous resin | 1.60 | 52 | 4200 | 4500 | 3800 |
| 42 | 6.1 | Crystalline resin | Amorphous resin | 1.80 | 54 | 4100 | 4500 | 3800 |
| 43 | 6.1 | Crystalline resin | Amorphous resin | 1.80 | 54 | 1000 | 900 | 900 |

| | | | | | | | |
|---|---|---|---|---|---|---|---|
| 44 | 6.1 | No domain-matrix structure | — | — | 38000 | 35000 | 32000 |

TABLE 9-2

| | Thermo- | THF-insoluble fraction | | |
|---|---|---|---|---|
| | physical | THF-insoluble | Incineration | Incineration ash/THF- |
| | properties | fraction | ash | insoluble fraction |
| Toner | ΔH | (mass %) | (mass %) | (mass %) |
| 1 | 10 | 30 | 13 | 43% |
| 2 | 10 | 30 | 13 | 43% |
| 3 | 10 | 30 | 13 | 43% |
| 4 | 10 | 25 | 8 | 32% |
| 5 | 10 | 23 | 6 | 26% |
| 6 | 10 | 35 | 13 | 37% |
| 7 | 10 | 35 | 13 | 37% |
| 8 | 10 | 30 | 13 | 43% |
| 9 | 10 | 30 | 13 | 43% |
| 10 | 10 | 40 | 23 | 58% |
| 11 | 10 | 18 | 6 | 33% |
| 12 | 12 | 18 | 6 | 33% |
| 13 | 10 | 13 | 6 | 46% |
| 14 | 10 | 40 | 13 | 33% |
| 15 | 10 | 45 | 13 | 29% |
| 16 | 10 | 55 | 23 | 42% |
| 17 | 10 | 30 | 13 | 43% |
| 18 | 10 | 30 | 13 | 43% |
| 19 | 10 | 30 | 13 | 43% |
| 20 | 10 | 30 | 13 | 43% |
| 21 | 10 | 30 | 13 | 43% |
| 22 | 8 | 30 | 13 | 43% |
| 23 | 7 | 30 | 13 | 43% |
| 24 | 4 | 30 | 13 | 43% |
| 25 | 14 | 30 | 13 | 43% |
| 26 | 7 | 30 | 13 | 43% |
| 27 | 14 | 30 | 13 | 43% |
| 28 | 10 | 30 | 13 | 43% |
| 29 | 10 | 30 | 13 | 43% |
| 30 | 10 | 30 | 13 | 43% |
| 31 | 20 | 30 | 13 | 43% |
| 32 | 10 | 30 | 13 | 43% |
| 33 | 10 | 30 | 13 | 43% |
| 34 | 10 | 30 | 13 | 43% |
| 35 | 10 | 30 | 23 | 77% |
| 36 | 10 | 8 | 1 | 13% |
| 37 | 10 | 29 | 1 | 3% |
| 38 | 10 | 40 | 33 | 83% |
| 39 | 10 | 20 | 13 | 65% |
| 40 | 10 | 20 | 13 | 65% |
| 41 | 10 | 20 | 3 | 15% |
| 42 | 10 | 20 | 3 | 15% |
| 43 | 4 | 20 | 3 | 15% |
| 44 | 10 | 30 | 13 | 43% |

In the table, the THF-insoluble fraction denotes the content ratio of the tetrahydrofuran-insoluble fraction of the toner, and the incineration ash denotes the content ratio of incineration ash in the tetrahydrofuran-insoluble fraction of the toner.

No domains containing an amorphous resin were observed in a cross-sectional observation of Toner 44.

### Production Example of Magnetic Carrier 1

Magnetite 1 (intensity of magnetization 65 Am²/kg in a 1000/4n (kA/m) magnetic field) having a number-average particle diameter of 0.30 μm
Magnetite 2 (intensity of magnetization 65 Am²/kg in a 1000/4n (kA/m) magnetic field) having a number-average particle diameter of 0.50 μm

Herein 4.0 parts of a silane compound (3-(2-aminoethylaminopropyl)trimethoxysilane) were added relative to 100 parts of each of the above materials, with high-speed mixing and stirring at 100° C. or above inside the vessel, to treat the respective fine particles.
Phenol: 10 mass %
Formaldehyde solution: 6 mass % (formaldehyde 40 mass %, methanol 10 mass %, water 50 mass %)
Magnetite 1 treated with the above silane compound: 58 mass %
Magnetite 2 treated with the above silane compound: 26 mass %

Then 100 parts of the above materials, 5 parts of a 28 mass % aqueous ammonia solution, and 20 parts of water were charged into a flask, the temperature was raised to 85° C. over 30 minutes while under mixing by stirring, and a polymerization reaction was conducted by holding that temperature for 3 hours, to cure the generated phenolic resin. The cured phenolic resin was then cooled down to 30° C., followed by further addition of water, after which the supernatant was removed, and the precipitate was washed with water and was subsequently air-dried. Next, the resulting product was dried under reduced pressure (5 mmHg or lower) at a temperature of 60° C., to yield a spherical Magnetic carrier 1 of magnetic body-dispersed type. The volume-basis 50% particle diameter (D50) of Magnetic carrier 1 was 34.2 μm.

### Production Example of Two-Component Developer 1

Herein 8.0 parts of Toner 1 were added to 92.0 parts of Magnetic carrier 1, and the whole was mixed using a V-type mixer (V-20, by Seishin Enterprise Co., Ltd.), to yield Two-component developer 1.

### Production Examples of Two-Component Developers 2 to 44

Two-component developers 2 to 44 were produced in the same way as in the production example of Two-component developer 1, but with the toner modified as given in Table 10.

TABLE 10

| Two-component developer | Toner particle | Carrier |
|---|---|---|
| Two-component developer 1 | Toner 1 | Carrier 1 |
| Two-component developer 2 | Toner 2 | Carrier 1 |
| Two-component developer 3 | Toner 3 | Carrier 1 |
| Two-component developer 4 | Toner 4 | Carrier 1 |
| Two-component developer 5 | Toner 5 | Carrier 1 |
| Two-component developer 6 | Toner 6 | Carrier 1 |
| Two-component developer 7 | Toner 7 | Carrier 1 |
| Two-component developer 8 | Toner 8 | Carrier 1 |
| Two-component developer 9 | Toner 9 | Carrier 1 |
| Two-component developer 10 | Toner 10 | Carrier 1 |
| Two-component developer 11 | Toner 11 | Carrier 1 |
| Two-component developer 12 | Toner 12 | Carrier 1 |
| Two-component developer 13 | Toner 13 | Carrier 1 |
| Two-component developer 14 | Toner 14 | Carrier 1 |
| Two-component developer 15 | Toner 15 | Carrier 1 |
| Two-component developer 16 | Toner 16 | Carrier 1 |
| Two-component developer 17 | Toner 17 | Carrier 1 |
| Two-component developer 18 | Toner 18 | Carrier 1 |
| Two-component developer 19 | Toner 19 | Carrier 1 |
| Two-component developer 20 | Toner 20 | Carrier 1 |
| Two-component developer 21 | Toner 21 | Carrier 1 |
| Two-component developer 22 | Toner 22 | Carrier 1 |
| Two-component developer 23 | Toner 23 | Carrier 1 |
| Two-component developer 24 | Toner 24 | Carrier 1 |
| Two-component developer 25 | Toner 25 | Carrier 1 |
| Two-component developer 26 | Toner 26 | Carrier 1 |
| Two-component developer 27 | Toner 27 | Carrier 1 |
| Two-component developer 28 | Toner 28 | Carrier 1 |
| Two-component developer 29 | Toner 29 | Carrier 1 |
| Two-component developer 30 | Toner 30 | Carrier 1 |
| Two-component developer 31 | Toner 31 | Carrier 1 |
| Two-component developer 32 | Toner 32 | Carrier 1 |
| Two-component developer 33 | Toner 33 | Carrier 1 |
| Two-component developer 34 | Toner 34 | Carrier 1 |
| Two-component developer 35 | Toner 35 | Carrier 1 |
| Two-component developer 36 | Toner 36 | Carrier 1 |
| Two-component developer 37 | Toner 37 | Carrier 1 |
| Two-component developer 38 | Toner 38 | Carrier 1 |
| Two-component developer 39 | Toner 39 | Carrier 1 |
| Two-component developer 40 | Toner 40 | Carrier 1 |
| Two-component developer 41 | Toner 41 | Carrier 1 |
| Two-component developer 42 | Toner 42 | Carrier 1 |
| Two-component developer 43 | Toner 43 | Carrier 1 |
| Two-component developer 44 | Toner 44 | Carrier 1 |

### Example 1

An evaluation was performed using the above Two-component developer 1. Two-component developer 1 was introduced into a cyan developing device, using a remodeled printer imageRUNNER ADVANCE C7770 for digital commercial printing, by Canon Inc., as the image forming apparatus. The device was modified so as to allow freely setting the fixation temperature, process speed, DC voltage VDC of a developer carrier, charging voltage VD of an electrostatic latent image bearing member, and laser power. To evaluate image output, an FFh image (solid image) having a desired image ratio was outputted, and VDC, VD and laser power were adjusted so that the toner laid-on level on the FFh image, on paper, took on a desired value; the below-described evaluations were then carried out. Herein “FFh” denotes a value obtained by displaying 256 gradations in hexadecimal notation, with 00h as the first of the 256 gradations (white background portion) and FFh as the 256-th gradation (solid portion). The evaluations are based on the following evaluation methods; the results are given in Table 11.

Low-Temperature Fixability
Paper: GFC-081 (81.0 g/m²)

(sold by Canon Marketing Japan Inc.)
Laid-on level of toner on paper: 0.70 mg/cm²

(adjusted on the basis of the DC voltage VDC of the developer carrier, the charging voltage VD of the electrostatic latent image bearing member, and laser power)
Evaluation image: 2 cm×15 cm image in the center of the above A4 paper
Test environment: low-temperature, low-humidity environment: temperature 15° C./humidity 10% RH (hereafter “L/L”)
Fixation temperature: 100° C.
Process speed: 300 mm/sec

The above evaluation image was outputted, and low-temperature fixability was evaluated. The value of the rate of decrease of image density was taken as an evaluation index of low-temperature fixability. To evaluate the rate of decrease in image density, image density at a central portion was measured firstly using an X-Rite color reflection densitometer (500 series: by X-Rite Inc.). Next, a load of 4.9 kPa (50 g/cm²) was applied to the portion where the image density was measured, and the fixed image was rubbed (10 back-and-forth rubs) with lens-cleaning paper, whereupon image density was measured again. The rate of decrease of image density before and after rubbing was calculated on the basis of the expression below. The obtained rate of decrease of the image density was evaluated in accordance with the evaluation criteria below.

Rate of decrease of image density=(image density before rubbing—image density after rubbing)/(image density before rubbing)×100

Evaluation Criteria
A: rate of decrease of image density is lower than 2.0%
B: rate of decrease of image density is 2.0% or more and less than 5.0%
C: rate of decrease of image density is 5.0% or more and less than 10.0%
D: decrease rate of image density is 10.0% or more

Hot Offset Resistance
Paper: CS-064 (64.0 g/m²)

(sold by Canon Marketing Japan Inc.)
Laid-on level of toner on paper: 0.08 mg/cm²

(adjusted on the basis of the DC voltage VDC of the developer carrier, the charging voltage VD of the electrostatic latent image bearing member, and laser power)
Evaluation image: 2 cm×20 cm image on the long edge of the above A4 paper, in the paper feeding direction, while leaving a margin of 2 mm from the leading end of the paper
Test environment: normal-temperature, low-humidity environment: temperature 23° C./humidity 5% RH (hereafter “N/L”)
Fixation temperature: raised from 100° C. in 5° C. increments
Process speed: 300 mm/sec

The evaluation image was outputted, and hot offset resistance was evaluated according to the following criteria, according to the highest fixation temperature at which hot offset did not occur.

Evaluation Criteria
A: 140° C. or more
B: 120° C. or more and less than 140° C.
C: 100° C. or more and less than 120° C.
D: less than 100° C.

Character Reproducibility
Paper: GFC-081 (81.0 g/m²)

(sold by Canon Marketing Japan Inc.)
Laid-on level of toner on paper: 0.40 mg/cm²

(adjusted on the basis of the DC voltage VDC of the developer carrier, the charging voltage VD of the electrostatic latent image bearing member, and laser power)
Test environment: temperature 23° C./humidity 50% RH
Fixation temperature: 100° C.
Process speed: 300 mm/sec

The evaluation image below was outputted under the above conditions. In the outputted image there were disposed 100 (10×10) “Den” Kanji character (6 points, Mincho typeface) at 10 mm intervals from each other, and while leaving 5 mm leading and trailing end margins, and 5 mm left and right margins.

Then 100 “Den” characters were observed using a magnifying glass, the number of chipped characters was counted, and character reproducibility was determined in accordance with the criteria below.
A. Fewer than 3 chipped characters.
B. 3 or more and fewer than 6 chipped characters.
C. 6 or more and fewer than 10 chipped characters.
D. 10 or more chipped characters.

Dot Reproducibility
Paper: GFC-081 (81.0 g/m²)

(sold by Canon Marketing Japan Inc.)
Laid-on level of toner on paper: 0.40 mg/cm²

(adjusted on the basis of the DC voltage VDC of the developer carrier, the charging voltage VD of the electrostatic latent image bearing member, and laser power)
Test environment: temperature 23° C./humidity 50% RH
Fixation temperature: 100° C.
Process speed: 300 mm/sec

The evaluation images below were outputted under the above conditions. A halftone image formed out of isolated dots was outputted, while leaving 5 mm leading and trailing end margins and 5 mm left and right margins (dot printing rate: 10%).

The 100 isolated dots on the image were observed randomly using a magnifying glass, and the minor axis and major axis of each dot were measured, to work out a ratio of major axis to minor axis (value resulting from by dividing the major axis by the minor axis). Dot reproducibility was determined on the basis of the criteria below, using the maximum value of a ratio of the major axis to the minor axis among the 100 isolated dots.
A. The maximum value of the ratio of major axis to minor axis is less than 1.10.
B. The maximum value of the ratio of major axis to minor axis is 1.10 or more and less than 1.20.
C. The maximum value of the ratio of major axis to minor axis is 1.20 or more and less than 1.30.
D. The maximum value of the ratio of major axis to minor axis is 1.30 or more.

Charging Performance (Charge Retention) in a High-Temperature, High-Humidity-Environment

The triboelectric charge quantity of the toner was calculated by suctioning and collecting the toner on the electrostatic latent image bearing member using a metallic cylindrical tube and a cylindrical filter. Specifically, the triboelectric charge quantity of the toner on the electrostatic latent image bearing member was measured using a Faraday cage. The Faraday cage herein is a coaxial double cylinder such that the inner cylinder and outer cylinder are insulated from each other. When a charged body having a charge quantity of Q is placed in the inner cylinder a state is brought about, on account of electrostatic induction, that is identical to that as if a metal cylinder having a charge quantity Q was present. This induced charge quantity was measured using an electrometer (Keithley 6517A, by Keithley Instruments Inc.), and the quotient (Q/M) resulting from dividing the charge quantity Q (mC) by the toner mass M (kg) in the inner cylinder was taken as the triboelectric charge quantity of the toner.

Triboelectric charge quantity of toner (mC/kg)=Q/M

Firstly, the above evaluation image used in hot offset resistance was formed on the electrostatic latent image bearing member, the rotation of the electrostatic latent image bearing member was stopped prior to transfer of the evaluation image to the intermediate transfer member, and the toner on the electrostatic latent image bearing member was suctioned and collected using the metallic cylindrical tube and the cylindrical filter, whereupon “initial Q/M” was measured. Subsequently, the developing device was placed in an evaluation apparatus, in a high-temperature, high-humidity (H/H) environment (32° C., 80% RH), and was allowed to stand, as it was, for 2 weeks; thereafter, the same operation as that prior to standing was carried out, and the charge quantity Q/M (mC/kg) per unit mass on the electrostatic latent image bearing member after standing was measured. With [initial Q/M] as the Q/M per unit mass on the electrostatic latent image bearing member before standing and [Q/M after standing] as the Q/M per unit mass on the electrostatic latent image bearing member after standing, the charging retention rate was calculated as ([Q/M after standing]/[initial Q/M]×100), and was assessed in accordance with the following criteria.

Evaluation Criteria
A: Retention rate is 85% or more
B: Retention rate is 80% or more and less than 85%
C: Retention rate is 70% or more and less than 80%
D: Retention rate is less than 70%

Storability

Herein 5 g of toner were placed in a 100 mL resin-made cup, the cup was allowed to stand for 72 hours in a thermostatic bath with variable temperature and humidity (50° C.; 54%), and then toner aggregation after standing was evaluated. Aggregation was evaluated, using a powder tester PT-X by Hosokawa Micron Corporation, in the form of the residual rate of remaining toner upon shaking for 10 seconds at an amplitude of 0.5 mm, through a mesh having a mesh opening of 150 μm. A rating of C or better was deemed as good.

Evaluation Criteria
A: Residual rate is less than 2.0%
B: Residual rate is 2.0% or more and less than 5.0%
C: Residual rate is 5.0% or more and less than 10.0%
D: Residual rate is 10.0% or more

### Examples 2 to 35 and Comparative Examples 1 to 9

Evaluations were performed in the same way as in Example 1, but using herein Two-component developer 2 through Two-component developer 44 instead of Two-component developer 1. The evaluation results are given in Table 11.

TABLE 11

| | | Low-temperature | | | | Character | | Dot | | Charge | | | |
|---|---|---|---|---|---|---|---|---|---|---|---|---|---|
| | | fixability | | Hot offset | | reproducibility | | reproducibility | | retention | | Storability | |
| | Evaluation item | % | Rank | ° C. | Rank | % | Rank | % | Rank | % | Rank | % | Rank |
| Example 1 | Two-component developer 1 | 1.5 | A | 145 | A | 1 | A | 1.04 | A | 89 | A | 1.6 | A |
| Example 2 | Two-component developer 2 | 1.0 | A | 145 | A | 1 | A | 1.04 | A | 89 | A | 1.6 | A |
| Example 3 | Two-component developer 3 | 1.1 | A | 145 | A | 1 | A | 1.14 | B | 88 | A | 1.4 | A |
| Example 4 | Two-component developer 4 | 1.0 | A | 140 | A | 4 | B | 1.14 | B | 88 | A | 1.4 | A |
| Example 5 | Two-component developer 5 | 1.2 | A | 130 | B | 8 | C | 1.16 | B | 88 | A | 1.4 | A |
| Example 6 | Two-component developer 6 | 2.1 | B | 145 | A | 1 | A | 1.14 | B | 88 | A | 1.4 | A |
| Example 7 | Two-component developer 7 | 2.2 | B | 145 | A | 1 | A | 1.14 | B | 88 | A | 1.4 | A |
| Example 8 | Two-component developer 8 | 1.2 | A | 145 | A | 1 | A | 1.14 | B | 88 | A | 1.4 | A |
| Example 9 | Two-component developer 9 | 3.0 | B | 145 | A | 1 | A | 1.14 | B | 88 | A | 1.4 | A |
| Example 10 | Two-component developer 10 | 8.0 | C | 150 | A | 0 | A | 1.14 | B | 88 | A | 1.4 | A |
| Example 11 | Two-component developer 11 | 1.8 | A | 115 | C | 8 | C | 1.18 | B | 88 | A | 1.4 | A |
| Example 12 | Two-component developer 12 | 0.8 | A | 115 | C | 8 | C | 1.18 | B | 88 | A | 1.4 | A |
| Example 13 | Two-component developer 13 | 1.2 | A | 110 | C | 9 | C | 1.18 | B | 88 | A | 1.4 | A |
| Example 14 | Two-component developer 14 | 3.5 | B | 145 | A | 0 | A | 1.14 | B | 88 | A | 1.4 | A |
| Example 15 | Two-component developer 15 | 4.0 | B | 145 | A | 0 | A | 1.12 | B | 88 | A | 1.0 | A |
| Example 16 | Two-component developer 16 | 9.0 | C | 150 | A | 0 | A | 1.12 | B | 88 | A | 1.0 | A |
| Example 17 | Two-component developer 17 | 1.5 | A | 145 | A | 1 | A | 1.14 | B | 88 | A | 1.4 | A |
| Example 18 | Two-component developer 18 | 1.6 | A | 145 | A | 1 | A | 1.14 | B | 88 | A | 1.4 | A |
| Example 19 | Two-component developer 19 | 1.5 | A | 145 | A | 1 | A | 1.14 | B | 88 | A | 1.4 | A |
| Example 20 | Two-component developer 20 | 1.5 | A | 145 | A | 1 | A | 1.14 | B | 88 | A | 1.4 | A |
| Example 21 | Two-component developer 21 | 1.4 | A | 145 | A | 1 | A | 1.14 | B | 88 | A | 1.4 | A |
| Example 22 | Two-component developer 22 | 1.8 | A | 145 | A | 1 | A | 1.14 | B | 88 | A | 1.4 | A |
| Example 23 | Two-component developer 23 | 2.4 | B | 145 | A | 1 | A | 1.14 | B | 88 | A | 1.4 | A |
| Example 24 | Two-component developer 24 | 7.0 | C | 145 | A | 1 | A | 1.14 | B | 88 | A | 1.0 | A |
| Example 25 | Two-component developer 25 | 0.8 | A | 145 | A | 1 | A | 1.14 | B | 88 | A | 1.4 | A |
| Example 26 | Two-component developer 26 | 3.5 | B | 145 | A | 1 | A | 1.14 | B | 88 | A | 1.4 | A |
| Example 27 | Two-component developer 27 | 1.0 | A | 145 | A | 1 | A | 1.14 | B | 88 | A | 1.4 | A |
| Example 28 | Two-component developer 28 | 1.0 | A | 145 | A | 4 | B | 1.22 | C | 86 | A | 1.4 | A |
| Example 29 | Two-component developer 29 | 4.0 | B | 145 | A | 5 | B | 1.14 | B | 88 | A | 1.4 | A |
| Example 30 | Two-component developer 30 | 4.0 | B | 145 | A | 7 | C | 1.22 | C | 86 | A | 1.4 | A |
| Example 31 | Two-component developer 31 | 1.6 | A | 120 | B | 9 | C | 1.28 | C | 88 | A | 1.4 | A |
| Example 32 | Two-component developer 32 | 1.8 | A | 140 | A | 5 | B | 1.18 | B | 72 | C | 1.8 | A |
| Example 33 | Two-component developer 33 | 3.5 | B | 140 | A | 5 | B | 1.18 | B | 74 | C | 1.8 | A |
| Example 34 | Two-component developer 34 | 0.8 | A | 115 | C | 8 | C | 1.24 | C | 87 | A | 2.4 | B |
| Example 35 | Two-component developer 35 | 8.5 | C | 150 | A | 0 | A | 1.04 | A | 87 | A | 2.2 | B |
| Comparative example 1 | Two-component developer 36 | 1.2 | A | 100 | C | 12 | D | 1.36 | D | 87 | A | 4.6 | B |
| Comparative example 2 | Two-component developer 37 | 1.2 | A | 100 | C | 12 | D | 1.32 | D | 87 | A | 4.6 | B |
| Comparative example 3 | Two-component developer 38 | 12.0 | D | 135 | B | 0 | A | 1.16 | B | 87 | A | 2.4 | B |
| Comparative example 4 | Two-component developer 39 | 13.0 | D | 130 | B | 4 | B | 1.24 | C | 87 | A | 3.0 | B |
| Comparative example 5 | Two-component developer 40 | 15.0 | D | 130 | B | 4 | B | 1.24 | C | 87 | A | 3.0 | B |
| Comparative example 6 | Two-component developer 41 | 3.4 | B | 120 | B | 12 | D | 1.22 | C | 87 | A | 4.0 | B |
| Comparative example 7 | Two-component developer 42 | 4.0 | B | 120 | B | 12 | D | 1.36 | D | 87 | A | 4.0 | B |
| Comparative example 8 | Two-component developer 43 | 1.6 | A | 90 | D | 20 | D | 1.40 | D | 82 | B | 12.0 | D |
| Comparative example 9 | Two-component developer 44 | 12.0 | D | 135 | B | 0 | A | 1.16 | B | 81 | B | 7.5 | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-059846, filed Mar. 31, 2022, which is hereby incorporated by reference herein in its entirety.

What is claimed is:

1. A toner, comprising a toner particle comprising a binder resin,
wherein in a viscoelasticity measurement performed on a molded sample resulting from compression molding of the toner to a disc shape, and in which a strain in the molded sample is caused to vary, at 90° C.,
a storage elastic modulus G′(1) of the molded sample at 1% strain is 7500 to 30000 Pa, and
a storage elastic modulus G′(50) of the molded sample at 50% strain is 950 to 6000 Pa.

2. The toner according to claim 1, wherein a content ratio of a tetrahydrofuran-insoluble fraction of the toner is 12 to 60 mass %, based on a mass of the toner.

3. The toner according to claim 1, wherein a content ratio of an incineration ash of a tetrahydrofuran-insoluble fraction of the toner is 5 to 30 mass % based on a mass of the toner.

4. The toner according to claim 1,
wherein the binder resin comprises a crystalline resin, and
in a differential scanning calorimetric measurement of the toner as a sample,
a peak temperature of an endothermic peak corresponding to the crystalline resin, in a first temperature rise, is 50 to 70° C., and
an endothermic quantity ΔH (J/g) of the endothermic peak satisfies ΔH≥5.

5. The toner according to claim 4,
wherein the binder resin further comprises an amorphous resin;
and the amorphous resin is a polyester resin.

6. The toner according to claim 1,
wherein the binder resin comprises a crystalline resin and an amorphous resin; and
in a cross-sectional observation of the toner particle using a transmission electron microscope,
the binder resin has a domain-matrix structure made up of a matrix comprising the crystalline resin and domains comprising the amorphous resin.

7. The toner according to claim 5, wherein the amorphous resin comprises monomer units corresponding to an alkenylsuccinic acid.

8. The toner according to claim 1,
wherein in the viscoelasticity measurement in which strain in the molded sample is caused to vary, at 90° C.,
the G′(1) and a loss elastic modulus G″(1) of the molded sample at 1% strain satisfy G′(1)>G″(1).

9. A toner, comprising a toner particle comprising a binder resin,
wherein the binder resin comprises a crystalline resin;
the crystalline resin is a crystalline vinyl resin
having at least first monomer units represented by Formula (1); and
having at least two of monomer units selected from the group consisting of second monomer units represented by Formula (2), or
having second monomer units represented by Formula (2) and third monomer units represented by Formula (3); and
a content ratio of an incineration ash of a tetrahydrofuran-insoluble fraction of the toner is 5 to 30 mass % based on a mass of the toner: 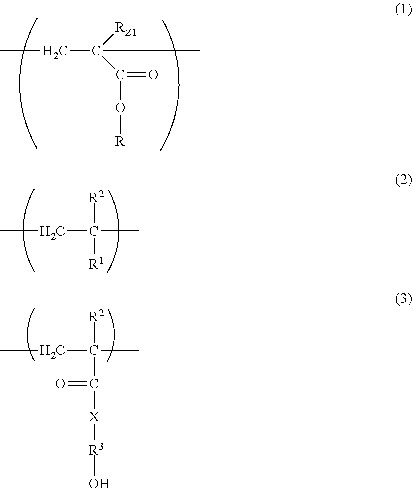
in Formula (1), R_{z1} represents a hydrogen atom or a methyl group, and R represents an alkyl group having 18 to 36 carbon atoms;
in Formula (2), R¹ is —C≡N,
—C(═O)NHR¹⁰ (where R¹⁰ represents a hydrogen atom or an alkyl group having 1 to 4 carbon atoms),
a hydroxy group,
—COOR¹¹ (where R¹¹ represents a hydrogen atom or an alkyl group having 1 to 6 carbon atoms), or
—NH—C(═O)—N(R¹³)₂ (where the two R¹³ represent each independently a hydrogen atom or an alkyl group having 1 to 6 carbon atoms), and
R² represents a hydrogen atom or a methyl group; and
in Formula (3), X represents 0 or NH, R² represents a hydrogen atom or a methyl group, and R³ represents an alkylene having 2 to 6 carbon atoms.

10. The toner according to claim 9, wherein the crystalline resin is a crystalline vinyl resin having the first monomer units represented by Formula (1), the second monomer units represented by Formula (2) and the third monomer units represented by Formula (3).

11. A two-component developer comprising a toner and a magnetic carrier, wherein the toner is the toner according to claim 1.

12. A two-component developer comprising a toner and a magnetic carrier, wherein the toner is the toner according to claim 9.
